(19) United States
(12) Patent Application Publication
(10) Pub. No.: US 2004/0249712 A1
(43) Pub. Date: Dec. 9, 2004

(54) System, method and computer program product for presenting, redeeming and managing incentives

(76) Inventors: Sean D. Brown, San Francisco, CA (US); William M. Vickers, Los Angeles, CA (US); Heather Kobrin, Mill Valley, CA (US)

Correspondence Address: SQUIRE, SANDERS & DEMPSEY L.L.P, 600 HANSEN WAY, PALO ALTO, CA, 94304-1043, US

(21) Appl. No.: 10/861,684

(22) Filed: Jun. 4, 2004

Related U.S. Application Data
(60) Provisional application No. 60/476,729, filed on Jun. 6, 2003.

(51) Int. Cl. G06F 17/60

(52) U.S. Cl. 705/14

(57) ABSTRACT

A system, method and computer program product are disclosed for presenting, redeeming and managing incentives. In one embodiment, a set of incentives may be presented to a consumer to permit the consumer to select at least one incentive from the set. Via a network, a notification may be received that identifies the incentive(s) selected by the consumer. Information relating to each selected incentive may be stored in a database. This information may include information that identifies the consumer that selected the incentive, information that identifies the selected incentive, and information that identifies a retailer associated with the selected incentive. Subsequently, a query may be received from a point of sale of a retailer via the network. The query identifies a consumer and a retailer and indicates that a sales transaction involving the customer is occurring at the point of sale of the retailer. In response to the query, a determination may be made to determine whether any of the selected incentives stored in the database are associated with the retailer and the consumer. If one or more of the incentives selected by the consumer stored in the database are determined to be associated with the retailer, then a reply may be transmitted to the point of sale of the retailer via the network. The reply identifies which of the stored selected incentives were determined to be associated with the retailer. Based on the information contained in the reply, the retailer then determines which of the identified selected incentives apply to the sales transaction with the consumer. These incentives may then be applied to the sales transaction. After the sales transaction is completed at the point of sale, a report may be received from the point of sale via the network that identifies the incentives that were applied to the sales transaction. The information stored in the database may then be updated to reflect application of the incentives to the consumer transaction.

### CROSS-REFERENCE TO RELATED APPLICATIONS

This application claims the benefit of U.S. Provisional Application Ser. No. 60/476,729, filed Jun. 6, 2003.

### TECHNICAL FIELD

This invention relates to incentive, and more particularly, relates to systems for managing and utilizing incentives.

### BACKGROUND

Coupons are the number one, non-store specific marketing vehicle used by retailers and product manufacturers to drive consumer traffic to retail stores. In 2002, businesses spent over $6 billion to distribute 335 billion coupons, delivered predominantly through communication mediums such as direct mail, newsprint, promotional publications (e.g. catalogs), and free standing inserts (FSI's) in newspapers. However, despite the proliferation of coupons in the marketplace, they have an overall redemption rate of only 1.1%. This is primarily due to the fact that consumers find them either irrelevant to their immediate shopping needs, inconvenient to physically clip and carry, or simply forget to take them to the store when they go shopping.

Over the last five years, the advent of Internet technologies has presented a new channel for distributing coupons. But, even though Internet coupons are delivered to consumers electronically, consumer's must still print the coupons and physically take them to the store in order to redeem—which makes Internet coupons no more convenient for consumers than ordinary paper coupons. Many retailers and product manufacturers have also been reticent to utilize Internet coupons because they are more susceptible to fraudulent usage, since email makes it simple for consumers to reproduce and disseminate Internet coupons beyond their intended distribution area.

### SUMMARY

Embodiments of the present invention provide a way for consumers to electronically clip coupons from virtually any media source—both on-line and off-line—and redeem either in physical stores or on-line without the need to physically clip or print a paper coupon.

A system, method and computer program product are disclosed for presenting, redeeming and managing incentives. In one embodiment, a set of incentives may be presented to a consumer to permit the consumer to select at least one incentive from the set. Via a network, a notification may be received that identifies the incentive(s) selected by the consumer. Information relating to each selected incentive may be stored in a database. This information may include information that identifies the consumer that selected the incentive, information that identifies the selected incentive, and information that identifies a retailer associated with the selected incentive. Subsequently, a query may be received from a point of sale of a retailer via the network. The query identifies a consumer and a retailer and indicates that a sales transaction involving the customer is occurring at the point of sale of the retailer. In response to the query, a determination may be made to determine whether any of the selected incentives stored in the database are associated with the retailer and the consumer. If one or more of the incentives selected by the consumer stored in the database are determined to be associated with the retailer, then a reply may be transmitted to the point of sale of the retailer via the network. The reply identifies which of the stored selected incentives were determined to be associated with the retailer. Based on the information contained in the reply, the retailer then determines which of the identified selected incentives apply to the sales transaction with the consumer. These incentives may then be applied to the sales transaction. After the sales transaction is completed at the point of sale, a report may be received from the point of sale via the network that identifies the incentives that were applied to the sales transaction. The information stored in the database may then be updated to reflect application of the incentives to the consumer transaction.

### BRIEF DESCRIPTION OF THE DRAWINGS

FIG. 1 is a schematic block diagram of an illustrative environment for implementing embodiments of the present invention;

FIG. 2 is a flowchart of a process for presenting and redeeming incentives utilizing an incentive manager in an incentive management system in accordance with an embodiment of the present invention;

FIG. 3 is a schematic representation of a process flow for an incentive management system in accordance with an embodiment of the present invention;

FIG. 4 is a schematic block diagram of an exemplary layout of an interface that may be displayed at a kiosk in accordance with an embodiment of the present invention;

FIG. 5 is a schematic block flow diagram of a consumer registration process in accordance with an embodiment of the present invention;

FIG. 6 is a block diagram illustrating a linking of pages associated with a Find Deals page via selection of a marketing partner's button in accordance with an embodiment of the present invention;

FIG. 7 is a schematic block diagram illustrating a relationship between a marketing partner's home page in an incentive managing system to a Competitive Advantage page of the marketing partner in accordance with an embodiment of the present invention;

FIG. 8 is a schematic block diagram illustrating a log in process for accessing a marketing partner/retailer home page in an incentive management system in accordance with an embodiment of the present invention;

FIG. 9 is schematic block diagram illustrating inbound text messaging paths to a marketing partner/retailer page in an incentive management system in accordance with an embodiment of the present invention;

FIG. 10 is a schematic diagram of an illustrative network system with a plurality of components in accordance with an embodiment of the present invention;

FIG. 11 is a schematic diagram of a representative hardware environment in accordance with an embodiment of the present invention;

FIG. 12 is a flowchart of a process for using a text messaging to select digital incentives in accordance with an embodiment of the incentive management system; and

FIG. 13 is a flowchart of a process for using text messaging to deliver incentives to one or more consumers in accordance with an embodiment of the incentive management system.

### DETAILED DESCRIPTION

In accordance with embodiments of the present invention, electronic coupons may help improve coupon redemption rates by making it more convenient for consumers to use where and when they wish—either in a physical store or on a web site. To clip an electronic coupon from an on-line medium, such as a web site or email, a consumer simply clicks a link to a URL that accesses a web-based application in order to process the request. This link may be visually displayed as an icon or hotlink on the on-line coupon. After logging on to the application, the consumer is linked to selected coupons and the transactions are stored in the database. The electronic coupons may subsequently be redeemed by the consumer either on-line on the retailer's web site or within the physical store via a web-enabled device resident at the point of sale (POS).

To clip an electronic coupon from an off-line media source (i.e. newsprint advertisements, sales circulars, free-standing inserts (FSI), outdoor media, television, etc.) a consumer may use a telephone to access the application. If the phone is web-enabled, the consumer may use the phone's browser to connect to a URL that will access the web-based application in order to process the request. After logging on to the application, the consumer may then use the wireless device's keypad or scanner (if applicable) to capture the coupon's unique identifier (promo code) which is displayed in the advertisement. If the phone is short message service (SMS)-enabled, the consumer may send a text message in order to process the request. After logging on to the application, the consumer may then use the wireless device's keypad or scanner (if applicable) to enter the coupon's unique identifier (promo code), which is displayed in the advertisement. The consumer is linked to the selected coupons and the transactions are stored in the database. The electronic coupons may subsequently be redeemed by the consumer either on-line on the retailer's web site or within the physical store via a web-enabled device resident at the POS.

Consumers may also use touch-tone telephones to clip electronic coupons from an off-line media source by calling a specified phone number and utilizing an automated phone process to access the application and enter selected coupons' unique identifiers (promo codes). The consumer is linked to the selected coupons and the transaction is transmitted to the database. As before, the electronic coupon may subsequently be redeemed by the consumer either on-line on the retailer's web site or within the physical store via a web-enabled device resident at the POS.

In addition to positively impacting redemption rates, the electronic coupons may also provide retailers with value-added marketing capabilities. For instance, because each consumer and each electronic coupon is assigned a unique identifier, consumers can be identified and matched to electronic coupons so that future promotional offers can be tailored to fit consumers' personal wants and needs based upon electronic coupons previously redeemed. Retailers may also maximize their advertising effectiveness by sending expiration reminder notices to consumers before the expiration date(s) of selected electronic coupons. Plus, electronically linking coupons with consumers reduces the risk of fraudulent coupon usage by providing retailers with the option of making coupons non-transferable, invalid with other promotional offers, or valid only one time per consumer within a particular timeframe.

Because each electronic coupon possesses a unique identifier (promo code), retailers will also have the ability to track their marketing effectiveness in real-time to a degree previously unobtainable, such as individual coupon performance (clipped and redeemed), the performance of individual on-line and off-line media sources, and even electronic coupons clipped by consumers that were unredeemed.

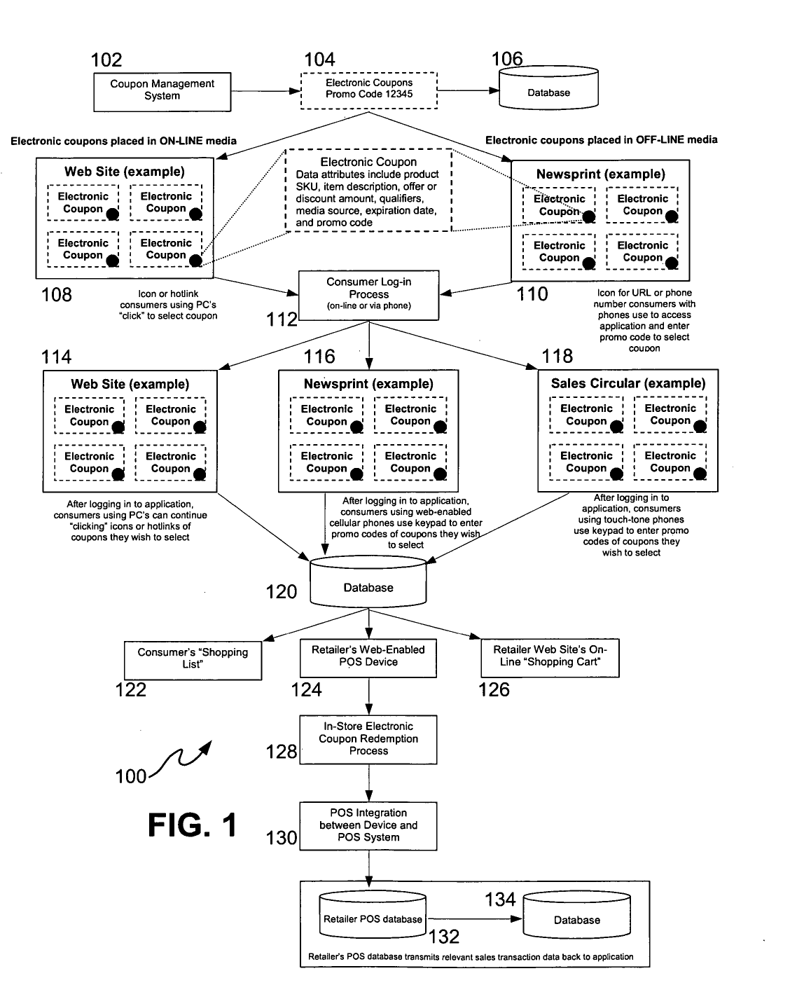

FIG. 1 is a schematic block diagram of an illustrative environment 100 for implementing embodiments of the present invention. With reference to FIG. 1, a retailer utilizes an online coupon management system 102 to create electronic coupons 104 that match those published in online or off-line media sources as part of the retailer's established marketing campaigns. The electronic coupons 104 may include all pertinent data attributes of the published coupons, including item description, product SKU, offer or discount amount, qualifiers, expiration date, and media source. The coupon management system 102 generates a unique coupon identifier (a “promo code”) for each electronic coupon 104 for use both online and off-line. Retailers may choose to make electronic coupons 104 transferable from one consumer to another, invalid with any other promotional offers, or valid only one time per consumer within a particular timeframe. All electronic coupons 104 may be saved to (i.e. store in) a database 106. It should also be noted that while the term “retailer” as utilized herein may, in at least one embodiment, be understood to include retailers of goods and/or services and may further include, for example, restaurants, movie theaters, sporting venues, and the like.

With continuing reference to FIG. 1, coupons published in online mediums 108 (i.e. retailer's web site, third-party web site, one-to-one email, mass email campaigns, etc.) may include redemption instructions and a unique coupon identifier (promo code) represented as an icon or hotlink to a URL that accesses the web-based application in order to process the request. An electronic coupon may possess all data attributes previously discussed. Coupons published in off-line media sources 110 may include redemption instructions and each coupon a unique coupon identifier (promo code). These access instructions may read as “Log on to the URL using your web-enabled device or call the following number and enter the electronic coupon's promo code when prompted.”

Upon accessing the URL or phone connection (for those using touch-tone telephones) consumers may be asked to identify themselves by logging in to the application (see element 112). Each consumer may be provided with a unique ID or “consumer identifier” that may be used to match the consumer to selected electronic coupons. Consumers may be prompted to log in to the application only one time per session to make the experience as convenient as possible. Consumers may then clip multiple coupons from multiple media sources without having to log in to the application again.

After logging in to the application, consumers selecting electronic coupons online may simply click an icon or hotlink that is associated with each coupon (see element 114). Consumers selecting electronic coupons off-line from a web-enabled cellular phone may be prompted to enter each coupon's unique promo code using the phone's keypad or scanner, if applicable (see element 116). Consumers selecting electronic coupons off-line from a touch-tone telephone may be prompted to enter each coupon's unique promo code using the phone's keypad (see element 118). Electronic coupon selections may then be stored in the database 120.

In one embodiment, the selected electronic coupons may be immediately added to the consumer's “shopping list” 122 (i.e., list of selected coupons), that may be accessible via any web enabled device (PC, web terminal, web-enabled cellular phone, etc.) so that consumers have access to it anywhere they have access to the Internet or similar network. Contents of the “shopping list” 122 may be segmented by retailer and include relevant information regarding each electronic coupon the consumer has selected, including item description, product SKU, promo code, offer or discount amount, qualifiers, expiration date, and media source.

Selected electronic incentives may be immediately posted to the appropriate retailers' web-enabled point of sale (“POS”) devices 124 so consumers can redeem coupons in the store when they wish. Retailers may elect to have electronic coupons selected by consumers from both online and off-line communication mediums posted to the retailer's online “shopping cart” 126 (or “shopping bag”) so they may be redeemed on-line at the retailer's web site. Consumers shopping on-line at the retailer's web site will find selected electronic coupons in the retailer's on-line “shopping cart” or “shopping bag” 126.

To redeem pre-selected electronic coupons within a physical store (see element 128), the consumer may go to the store, shop for the products he or she wishes to purchase, and then proceed to the checkout area to complete the transaction. At checkout, the cashier may identify the consumer in the POS web-enabled device by inputting either the consumer's telephone number or name; or, by scanning a consumer loyalty card (if applicable to that retailer). The consumer's name and list of selected electronic coupons applicable to this particular retailer may then appear on a screen/display of the POS device. If the retailer's POS system is web enabled, the POS device may not be necessary to the process. The cashier may then select electronic coupons for redemption on the POS web-enabled device. The consumer's unique ID, promo codes, and retailer's coupon SKU's may then be transmitted from the POS web-enabled device to the retailers' POS system (where hardware integration is available) (see element 130). The retailer's POS system may be responsible for validation of the applicability of the coupon to the current transaction (i.e. retailer must set up corresponding SKU's from both the product and the electronic coupon within their POS system-much like they do today for paper coupon redemption). If hardware integration between the POS device and the retailer's POS system is unavailable, the clerk may then have to manually type the consumer's unique ID and relevant coupon SKU's into the POS system (again, much like they may do today for paper coupon redemption).

The retailer's POS system 132 transmits sales transaction data back to the database 134 for transactions involving the system, based upon the presence of a unique consumer identifier in the POS transaction record. This sales data may include the consumer's unique consumer identifier, promo codes for all redeemed electronic coupons, item descriptions and associated SKU's for all products purchased, and total purchase amount. Retailers, manufacturers, or third-party coupon companies may elect to have the system consolidate and forward electronically redeemed coupons to a third-party clearance house for ultimate fulfillment.

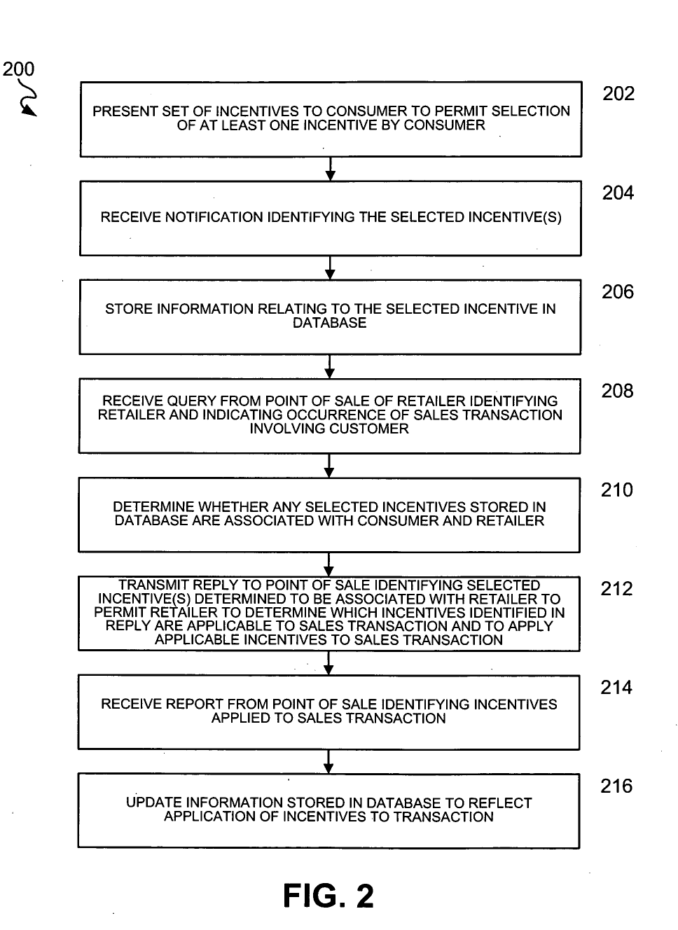

FIG. 2 is a flowchart of a process 200 for presenting and redeeming incentives utilizing an incentive manager in an incentive management system. In operation 202, a set of incentives may be presented to a consumer to permit the consumer to select at least one incentive from the set. Via a network, a notification may be received that identifies the incentive(s) selected by the consumer (see operation 204). Information relating to each selected incentive may be stored in a database in operation 206. This information may include information that identifies the consumer that selected the incentive, information that identifies the selected incentive, and information that identifies a retailer associated with the selected incentive. In operation 208, a query may be received from a point of sale of a retailer via the network. The query identifies a consumer and a retailer and indicates that a sales transaction involving the customer is occurring at the point of sale of the retailer. In response to the query, a determination may be made in operation 210 to determine whether any of the selected incentives stored in the database are associated with the retailer and the consumer. If one or more of the incentives selected by the consumer stored in the database are determined to be associated with the retailer, then in operation 212 a reply may be transmitted to the point of sale of the retailer via the network. The reply identifies which of the stored selected incentives were determined to be associated with the retailer. Based on the information contained in the reply, the retailer then determines which of the identified selected incentives apply to the sales transaction with the consumer. These incentives may then be applied to the sales transaction. After the sales transaction is completed at the point of sale, a report may be received from the point of sale in operation 214 via the network that identifies the incentives that were applied to the sales transaction. In operation 216, the information stored in the database may then be updated to reflect application of the incentives to the consumer transaction.

Each incentive may have an incentive identifier (also referred to as a “promo code”) associated therewith. In one embodiment, the reply may include the incentive identifier of each of the incentives selected by the consumer in order to identify the one or more selected incentives. In another embodiment, the presentation of the set of incentives may include a presentation of the associated incentive identifiers as well, so that a consumer may input one of the incentive identifiers in order to select its associated incentive. In such an embodiment, the incentive identifier may be input by the consumer into a wireless handheld device. The incentive identifier may even be input into the wireless handheld device utilizing text messaging via a text messaging service accessible through the wireless handheld device. Text messaging is a feature that allows text messages to be received on a wireless handset such as a cell phone. There includes at least two typical types of text messaging: one-way text messaging in which a user can only receive messages, and two-way text messaging in which a user can both receive, send, and reply to messages from the user's wireless handset.

In one embodiment, the set of incentives may be presented to the user/consumer in an off-line media source such as a print medium and/or a radio or television broadcast. As another option, the set of incentives may be presented to the consumer online—via a computer coupled to the network (e.g., the consumer's personal computer). In another embodiment, the set of incentives may be presented to the consumer at a kiosk coupled to the network. As a feature of such an embodiment, the incentives presented to the consumer in the set of incentives may be dependent on a physical (i.e., geographic) location of the kiosk. In one such embodiment, the kiosk may be located adjacent in a location of the retailer associated with at least one of incentives included in the set of incentives presented to the consumer. Further services may be provided to monitor the frequency that consumers access the kiosk and then reporting the monitored frequency of access to the retailer via the network.

The incentives included in the set of incentives may be selected based on responses of the consumer to a survey presented to the user via the network. In another embodiment, one or more additional incentives may be associated with an incentive (e.g. a primary incentive) so that if the primary incentive is presented to and selected by the consumer, then the associated additional incentive may be subsequently presented to the consumer. The additional associated incentives may be presented (via the network) to the consumer after determining from the report received from the point of sale of the retailer that the associated selected incentive was applied to the sales transaction. In one embodiment, the primary incentive selected by the consumer may relates to a service provided by a wireless network communication provider to provide further incentives to the consumer for frequenting a particular retailer and for using the services provided by the wireless network communication provider. The consumer may be permitted to preview the one or more incentives prior to selecting an incentive from the set of incentives so that the consumer can see the associations between primary incentives and their associated incentives prior to selection of the primary incentive. In one aspect, the consumer may be permitted to browse the set of incentives via a browser to view the associations between the incentives. The additional incentives may be presented via the network to the consumer upon receipt of the notification identifying the associated selected incentive (in which case the additional incentives may also be referred to as “up-sell incentives”). The additional incentives may comprise incentives associated with another retailer different than the retailer associated with the selected incentive (in which case, the additional incentives may be referred to as “cross sell incentives”).

In one embodiment, an unique consumer identifier may be received from the consumer prior to presentment of the set of incentives. The consumer identifier may be utilized to determine which of a plurality of pre-existing incentives to include in the set of incentives. In other words, the incentives included in the set of incentives presented to the consumer may be dependent on the consumer identifier received by the system. As an option, the consumer identifier may be included in a portable storage media (such as, e.g., a magnetic strip of a card (such as a credit card), a smart cart, a flash-memory type of memory device (e.g., a USB thumb-drive)) of the consumer, in which case, the consumer identifier may be obtained from the portable storage media upon coupling of the portable storage media to the network. The consumer identifier may be provided by the consumer to the point of sale of the retailer. In such an embodiment, the consumer identifier may be included in the query received from the point of sale of the retailer.

In one embodiment, information may be presented to the consumer that describe a benefit of a good or service associated with each incentive (or portion or group thereof) included in the set of incentives prior to selection of an incentive by the consumer. In another embodiment, the consumer may be permitted to input a calendar date of an event via the network. In this embodiment, one or more incentives relating to the event consumer may be then be presented to the consumer some time before (e.g., a predetermined amount of time) the calendar date of the event. In such an embodiment, the consumer may choose the medium (email, text message, etc.) in which the incentives associated to the event is to be presented.

In one embodiment, the consumer may be to input comments about the retailer and/or the selected incentive at the point of sale during the sale transaction. These comments may then be received from the point of sale via the network and stored in the database. In one embodiment, the consumer may be presented with another incentive based on the content of the comment. In yet another embodiment, the retailer may be presented with a list of incentives associated with the retailer via the network and another list identifying incentives associated with the retailer that have been redeemed by one or more consumers. These lists may be may be presented to the retailer utilizing a network browser. In another embodiment, an interface may be provided for permitting the retailer to create an incentive utilizing at least one of an incentive template and a pre-existing incentive.

In one embodiment, an email message may be transmitted to the consumer upon completion of the sale transaction. The email may include one or more further incentives that the consumer can select via the network. In such an embodiment, a notification may be received via the network after the further incentive(s) is selected with the notification identifying the consumer and the selected further incentive. This information may then be stored in the database as an entry associated with the consumer.

In one embodiment, the retailer may also be presented with a third list of incentives that identifies incentives associated with the retailer that have been selected by the consumer but that have not yet been redeemed by the consumer. With this list, the retailer and/or the incentive management system may measure interest in a particular incentive where consumers did not get around to redeeming the offers for whatever reason.

In another embodiment, one or more additional incentives may be presented to the consumer after receipt of the query. In such an embodiment, these additional incentive(s) may be presented to the consumer before the sales transaction at the point of sale is completed (which may be helpful for enhancing impulse purchases by the consumer while at the point of sale) and/or presented to the consumer after the sales transaction between the consumer and the retailer has been completed. In this embodiment, the additional incentive(s) presented to the consumer may be associated with one or more retailers such, as for example, the point of sale retailer and/or another retailer within a predetermined distance from the point of sale. Further, the presentment of the additional incentive(s) to the consumer may be timed so that the additional incentive(s) are presented to the consumer a set (i.e., predefined) amount of time after the sales transaction has been completed. This may be advantageous for presenting a cross-sale incentive to the consumer. For example, as soon as a consumer finishes the sales transaction at a clothing store in a mall or other shopping complex, the presentment of the additional incentive(s) may be set to an average amount of time that it takes a person to walk from the point of sale to the door of the retailers. The one or more additional incentives may also be presented to the consumer via a wireless handheld device. As an option, the one or more additional incentives may be presented to the consumer utilizing text messaging to the handheld wireless device.

In even another embodiment, a reminder associated with one of the selected incentives may be presented to the user subsequent selection of the incentive. For example, the reminder may be a sent to a consumer at a time based on a significant date input into the consumer's account (e.g., a birthday date, an anniversary date, a holiday date). In such an embodiment, the incentive management system may try to match appropriate incentives to the input date. For example, if a consumer inputs a wife's birthday into their account, and the consumer has previously selected an incentive associated with a jewelry store, the consumer may be sent a reminder by the incentive management system that reminds the consumer about the upcoming birthday and provide a suggestion for gifts appropriate for the occasion that may be purchased from the jewelry store using the selected incentive.

In yet another embodiment, at least one of the selected incentives may have an expiration time (e.g., an expiration date) after which the incentive may not be redeemed by the consumer. In this embodiment, a notice may be transmitted to the consumer a predetermined amount of time prior to the expiration time to help remind the consumer that the selected incentive will expire shortly. Such a notice may be transmitted via a network such as the Internet and may be sent via email, instant messaging or other service. In another embodiment, the notice may be transmitted over a wireless communication network to a handheld device of the consumer and presented to the consumer utilizing text messaging via a text messaging service.

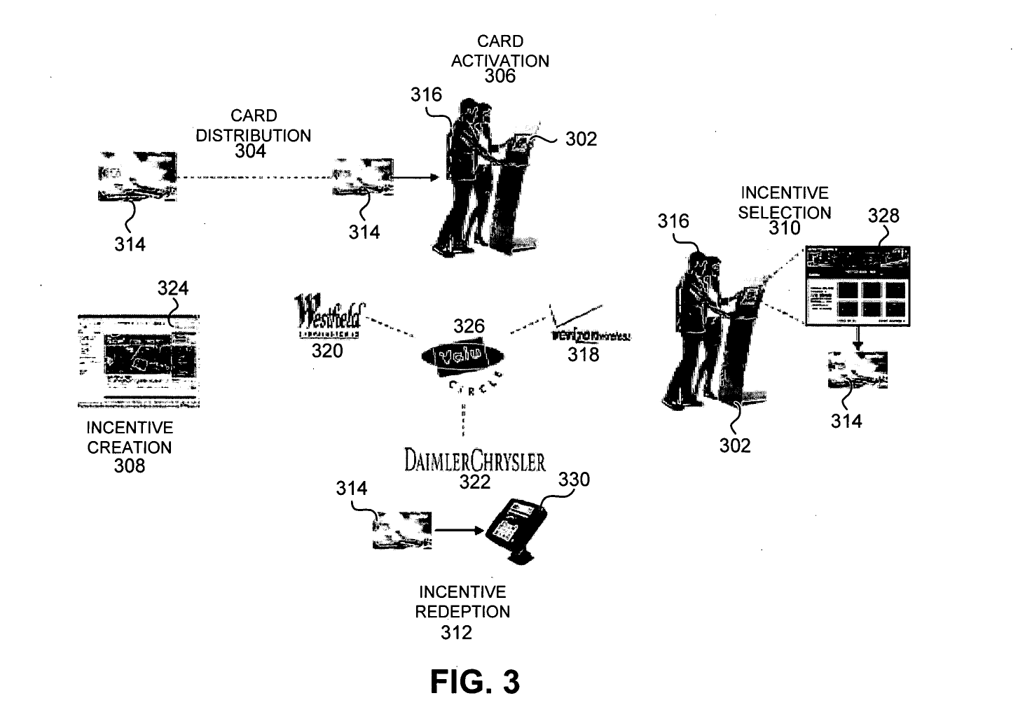

FIG. 3 is a schematic representation of a process flow for an incentive management system 300. In the embodiment illustrated in FIG. 3, the incentive management system 300 utilizes interactive kiosks 302 that may be located in shopping malls and retail stores to capture real-time consumer interactions. This embodiment of the incentive management system 300 may utilize several processes including a card distribution process 304, a card activation process 306, an incentive creation process 308, an incentive selection process 310 and an incentive redemption process 312.

In the card distribution process 304, consumers receive cards 314 (such as smart cards or magnetic strip cards) at various locations including high consumer traffic areas such as, for example, malls, public events and retail stores. In the card activation process 306, consumers 316 may activate their cards 314 by inserting into an interactive kiosk 302 and completing a registration process at the kiosk. Incentives for consumers may be created (for example by retailers 318, 320, 322) in the incentive creation process 308 via an administration portal 324 of the incentive manager 326. The incentives created may be based on consumer profile data (e.g., to create dynamic incentives), retailer initiatives (e.g., to create static incentives), or even on the fly (e.g., through the use of marketing campaigns) for example. In the incentive selection process 310, consumers 316 may select incentives at a kiosk 302 by selecting images associated with the incentive displayed in an incentive portal 328 on the kiosk screen. In one embodiment, selected incentives may be downloaded to the consumer's card 314. In another embodiment, the selected incentives may be transmitted from the kiosk to the incentive manager via a network. In the incentive redemption process 312, consumers may redeem their selected incentives by inserting their card 314 into a standalone reader 330 at a checkout or other point of sale device of a retailer.

Incentives

Incentives (also referred to as “digital incentives”) may be assigned a unique incentive identifier (also referred to as an “incentive management system ID number” or a “promo code”). A “selected” incentive may be defined as one that a consumer has chosen (i.e., selected) by either “touching at” an in-mall or in-store kiosk; or, by “clicking” on-line from a web site or email. The displayed incentive may be subsequently “highlighted” to indicate its selection. A “redeemed” incentive may be defined as one that a retailer has accepted on the POS device as part of the check-out process. The consumer may have the option to redeem incentives or not redeem incentives. Consumers choosing not to redeem incentives may still register their visit, benefit from any applicable frequency benefits, and be entered into any applicable sweepstakes. At a kiosk, consumers may “de-select” any incentive by pressing or clicking the displayed incentive a second time. The incentive is “un-highlighted” to indicate its cancellation. All selected incentives, including cross-marketing partners,' may be posted on each consumer's “My Deals” page (which is associated with the consumer's account with the incentive management system).

The incentive management system may be capable of implementing several categories of digital incentives such as, for example: primary incentives, up-sell incentives, popular incentives, bounce-back incentives, come-back incentives, deals of the day incentives, gift reminder incentives, and cross-sell incentives.

There may be three types of primary incentives including: generic incentives, dynamic incentives, and personalized incentives. Generic incentives may be available to all consumers logging on to the incentive management system on an in-mall or in-store kiosk. Dynamic incentives, created for consumers that take specific actions (such as responding to survey questions). Personalized incentives, created for individual consumers (based upon the incentive management system's personalization engine recommendations). The incentive management system personalization engine may combine consumer data collected from multiple sources, such as selected incentives, “Save on Next” choices, and personal preferences shared in order to create personalized incentive recommendations.

A primary incentive may have a plurality of “up-sell” incentives assigned to it. An “up-sell” incentive may be assigned to any primary incentive. Up-sell incentives may appear in a vertical row on the right-hand side of the page on which their associated primary incentive appears. In one embodiment, an “up-sell” incentive may not be available to the consumer unless the consumer selects the primary incentive to which up-sell incentive is assigned. As another option, each up-sell incentive may have the same expiration date and time as the primary incentive it is assigned to. Like primary incentives, selected up-sell incentives may be posted to the consumer's “My Deals” page until their redemption or expiration date.

“Popular” incentives are incentives selected most often by consumers within a given timeframe (i.e., today's 10 most selected incentives). “Popular” incentives may be placed in a “Popular Incentives” section of an “Incentive Selection” page. “Bounce-back” incentives for future purchases may be created for consumers that redeemed incentives with a retailer, and included on post-sale “Thank You” emails. “Bounce-back” incentives may be based upon the following elements of the transaction: (1) digital incentives redeemed; and (2) products purchased (if retailers upload POS Transaction log data). “Bounce-back” incentives may be placed in a “Personal Recommendations” section of an “Incentive Selection” page. “Come-back” incentives may be created for consumers with specific periods of inactivity (e.g., consumers with no recorded transactions in the past thirty-days). “Come-back” incentives may be delivered as content on eCirculars or text-message coupons. eCirculars are electronic booklets or groupings of various incentives delivered via email. “Come-back” incentives may be placed in a “Personal Recommendations” section of an “Incentive Selection” page. “Deals of the Day” incentives are generic incentives available to all consumers. “Deals of the Day” incentives may be placed in a “Deals of the Day” section of a “Find Deals” page displayed at kiosks of the incentive management system. “Gift Reminder” incentives are created for consumers in response to data collected via the gift reminder function of the incentive management system. “Gift Reminder” incentive notifications may be delivered as content on eCirculars or as text-messages. “Gift Reminder” incentives may be placed in the “Gift Registry Recommendations” section of an “Incentive Selection” page.

Cross-sell incentives are designed to allow retailers and marketing partners to participate in cooperative marketing campaigns. Retailers and marketing partners may choose to participate or not participate in cross-sell incentive programs. Cross-sell incentives may be directly associated with specific primary incentives offered by other retailers or marketing partners, and are activated by the redemption of the associated primary incentive (for instance, redemption of a DaimlerChrysler incentive “activates” an incentive at Panda Express). Each cross-sell incentive may have the same expiration date and time as the primary incentive it is assigned to. Selected cross-sell incentives may be available for redemption by consumers at the cross-selling retailer until their expiration date. In one embodiment, cross-sell incentives may be tied to participating businesses' hours of operation in order to prevent creation of a cross-sell incentive for a business that is closed on a particular day. Consumers may select “Cross-marketing” incentives like all other on-screen incentives and cross-sell incentives may be posted to consumers' “My Deals” just like all other incentives. Cross-sell incentive redemption process is similar to the other incentives.

Kiosks

Consumers may interact with kiosks placed throughout common areas of shopping malls or within retail stores. Consumers and cashiers may interact with a POS card reader which can be located adjacent to cash registers. In-mall kiosks and in-store kiosks may be located where consumers will exchange information and select incentives. POS card devices may be located where incentives are to be redeemed. Kiosks may be coupled to a network and may be capable of wireless communication with the network. In one embodiment, in-mall kiosks, in-store kiosks and POS card devices may connect to the Internet wirelessly. In-mall kiosks, in-store kiosks and POS card devices may be capable of reading and writing data to smart cards or other portable storage media devices (a flash-RAM type storage device or a magnetic storage media device). In one embodiment, each page display on an in-mall and in-store kiosks may have a default time-out period (such as, for example, one-minute) that will automatically reset the application to the “Intro” page after a period of inactivity.

A 10-digit phone number (preferably a cellular number) plus four-digit PIN may comprise a consumer's unique consumer identifier. In one embodiment, a consumer's 7-digit phone number (i.e., without the area code) may be utilized instead of the 10-digit phone number. In another embodiment, a “secret word” may be substituted for the four-digit PIN in case the consumer forgets the PIN. In a further embodiment, more than one consumer may be registered at the same 10-digit telephone number, but each consumer using that particular number should then have a unique four-digit PIN or secret word. In yet another embodiment, more than one consumer can be registered with the same name. Upon registration each consumer may be issued a card to be used for system identification at In-mall kiosks, in-store kiosks and POS card devices. Consumers may use their cards and four-digit PIN when interacting with POS smart card devices. Consumers may not use their “secret words” in lieu of the four-digit PIN at POS smart card devices. In one embodiment, the incentive management system should be capable of supporting a plurality of consumer languages (e.g., English and Spanish). Consumers may input data into a kiosk via an onscreen keyboard and number pad. The consumer may be able to cancel the process at any time by pressing the “Go!” (or exit) button displayed on the kiosk. Pressing the “Go!” button may also be utilized to update relevant incentive data to consumers' cards, and the cards may be automatically ejected from the kiosk. Audio and visual reminders should be utilized to instruct consumers to take their smart card with them (much like an ATM). The removal of the card signals the end of the transaction and the kiosk is re-set for the next consumer.

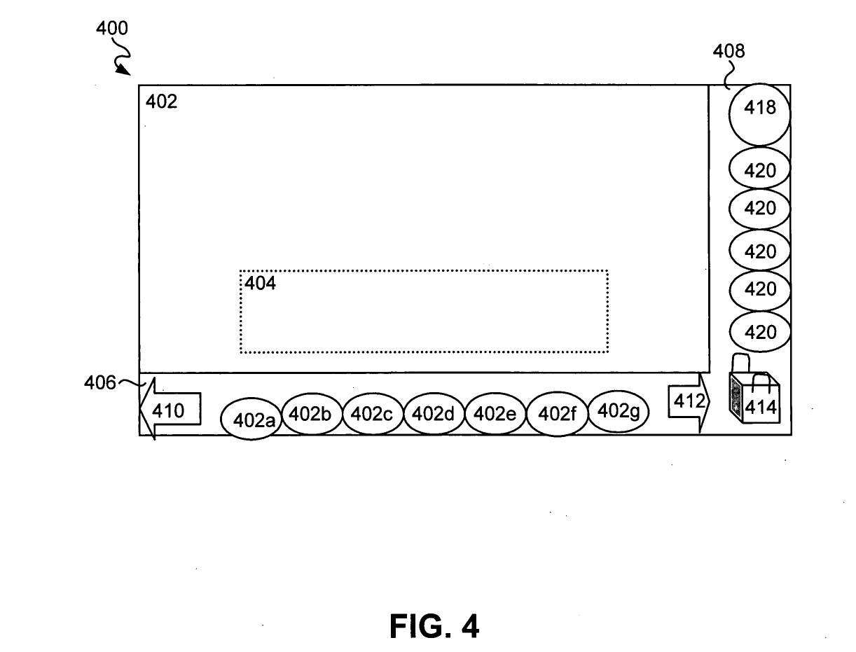

FIG. 4 is a schematic block diagram of an exemplary layout of an interface 400 that may be displayed at a kiosk in accordance with an embodiment of the present invention. As shown in FIG. 4, the interface 400 may include an area for displaying content 402 (page content area). In a portion of the page content area 402, an onscreen keyboard and/or number pad 404 may be displayed. The “Page Content Area” 402 is where specific web pages are displayed. Pages that appear in the “Page Content Area” may have their own navigation buttons.

As shown in the exemplary embodiment, the page content area 402 may be “framed” by horizontal and vertical navigation bars 406, 408 that display a plurality of user-selectable navigation buttons. In a preferred embodiment, navigation bars 406, 408 (with associated navigation buttons) appear with all displayed pages 402 while the onscreen keyboard 404 appears only when necessary.

The horizontal navigation bar 406 may contain a variety of navigation buttons (i.e., links or hyperlinks) which are available for selection by consumers to navigate between displayed pages of the incentive management system. In the exemplary embodiment, the horizontal navigation bar 406 may include a “Back” button 410 to move backward to a previous display, a “Next” button 412 to move forward to a subsequent display, and a “Go!” button 414 to save incentives to card and/or exit the application.

The horizontal navigation bar 406 may further include plurality of user-selectable application navigation buttons 416 that are linked to various other pages that may be displayed to a consumer. In an exemplary embodiment, the application navigation buttons 416 may include a “Find deals” button 416a that takes consumers to retailer incentive pages, a “My Deals” button 416b that takes consumers their list of previously selected incentives (i.e. virtual coupon book), an “About Me” button 416c that takes consumers to pages where they may create and manage their account and selected incentives (e.g., personal preferences, favorite brands, etc.), a “Sweepstakes and Free Stuff” button 416d that takes consumers to current sweepstakes and giveaway promotions pages, a “Gift Reminder” button 416e that takes consumers to pages where they can opt-in to receive email and text message reminders of personal occasions (e.g. mom's birthday) and upcoming holidays, a “Comment Card” button 416f that takes consumers to pages where they can provide retailers and marketing partners with feedback on their shopping experiences (this feedback may be directed to a predetermined email address) and a “Help” button 416g takes consumers to help texts, including online tutorials, FAQ's.

The vertical navigation bar 408 may also display a plurality of user-selectable links/buttons. In an exemplary embodiment, the vertical navigation bar 408 may include a “Marketing Partners” button 418 that takes consumers to a page where they may access a marketing partner's (e.g., Verizon Wireless) actual home page or its home page associated with the incentive management system. In one embodiment, this button 418 may displays rotating logos of marketing partners (e.g., Verizon Wireless) that serves as a link to the “Marketing Partners” page. The vertical navigation bar 408 may further include a plurality of “Consumers' Favorite Retailer” buttons 420 that take consumers to the incentive management system home pages of their favorite mall retailers. In one embodiment, each “Consumers'Favorite Retailer” button 420 may display a logo of associated retailers. A consumers' “favorite retailer” may be determined by survey response data collected on the “About Me” page and number of incentives redeemed associated with a particular retailer.

Displayed Pages of an Incentive Management System

Content presented by the incentive management system may be presented in a plurality of pages using, for example, the interface 400 of FIG. 4 as previously described. In general, specific content displayed on specific devices may be based upon device ID (i.e. locations) and specific timeframes. In addition, prioritization of content may be interactive, meaning that the application returns relevant content based upon consumer data input and responses to questions. As a further option, drop-down menus, radio buttons or other methods may be utilized for consumer data collection when the pages are displayed. The following, describes a number of exemplary content pages that may be displayed by the incentive management system.

Intro Page

Consumers may be greeted by an “Intro” page that displays promotional content. This page may take up the entire screen. Consumers may begin the process of logging-on to the incentive management system via the “Intro Page” of in-mall or in-store kiosks by inserting or swiping their card into the kiosk. The incentive management system “reads” the information contained in the card to identify the consumer as an existing consumer or new consumer (e.g., if the card does not contain any information about the consumer). Existing consumers may be taken to an “Existing Consumers Welcome” page while new consumers may be taken to a “New Consumers Welcome” page. For purposes of this description, existing consumers may be defined as those consumers already possessing an account with the incentive management system. Accordingly, new consumers may be defined as those consumers that do not possess an account with the incentive management system. As an option, existing consumers that forget or lose their cards may be able to log-on at kiosks by inserting a new (i.e., blank) card into the card reader. In such a scenario, the incentive management system will assume this to be a “new consumer” and take the consumer to the “New Consumer Welcome” page, where existing consumers may press an “I Forgot My Card” button in order to complete the log-on process. Default content on “intro” pages may be displayed during periods of device inactivity. This default content may be defined based upon a device ID (i.e. locations) of the kiosk (or other display device) and specific timeframes.

Existing Consumer Welcome Page

The “Existing Consumers' Welcome” page may contain promotional content of the incentive management system, instructions for system use, and an onscreen keyboard on which existing consumers that have inserted their cards may complete the log-on process by inputting their four-digit PIN on an onscreen keyboard. Consumers that have inserted their cards but forgot their PIN may be given the opportunity to complete the log-on process by substituting a “secret” word. After logging-on to incentive management system, existing consumers may be taken to the “Find Deals” page.

New Consumer Welcome Page

In the New Consumer Welcome Page, new consumers may be asked to select their preferred language (e.g., English or Spanish). The selected language may become their default language that is used for interacting with this consumer. New consumers may then be taken to the “First Name” page where they will begin a registration process with the incentive management system. In one embodiment, an “I Forgot My Card” button may also be displayed on the “New Consumers Welcome” page. This button will allow existing consumers to log on by inputting their 10-digit phone number (unique consumer identifier or consumer ID) plus four-digit PIN on an onscreen keyboard. This action will take consumers to the “Find Deals” page. At the end of the session, all applicable consumer ID and incentive data will be loaded onto the new card.

New Consumer Registration Pages

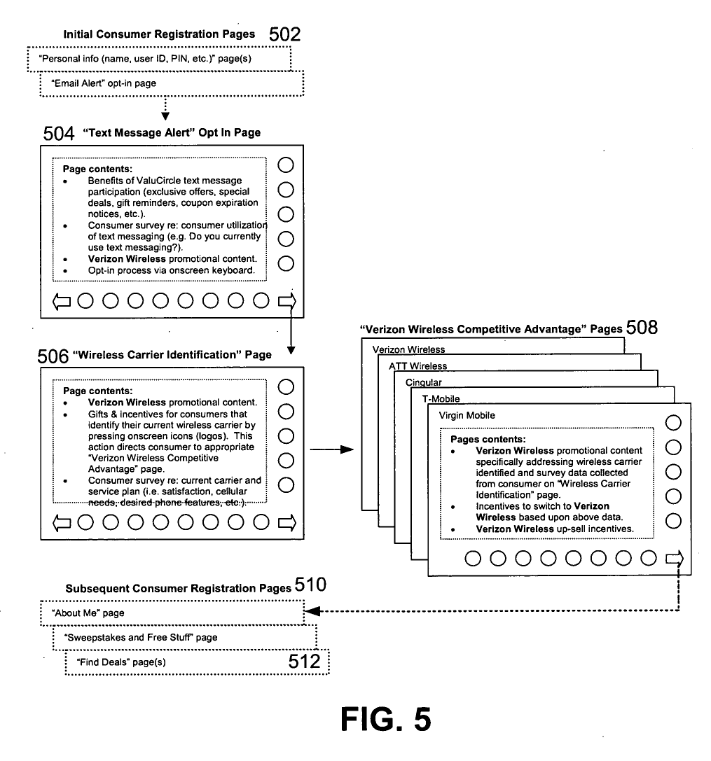

FIG. 5 is a schematic block flow diagram of a consumer registration process 500 in accordance with an embodiment of the present invention. Through this process, new consumer members may be presented with useful information on the benefits of incentive management system and are taken through the new member registration process outlined below. In general, consumers should only register with the incentive management system once. The consumer's unique log-on information may subsequently be accepted by any kiosk or POS card device on the incentive management system network.

Basic system registration of a new consumer may occur at in-mall and in-store kiosks and may be conducted in a one-question-per-page format, using a plurality of initial consumer registration pages 502 (e.g., a “First Name” page, a “Last Name” page, a “Ten-digit Phone Number (preferably cellular) page, a “Four-digit PIN” page, a “Secret Word” page (to be used in lieu of the 4-digit PIN in case the consumer forgets) and an optional “Email Address” page), an optional “Text Message Opt-in” page 504, an optional “Current Wireless Carrier Identification” page 506, one or more competitive advantage pages 508, and a plurality of subsequent consumer registration pages 510 (e.g., an “About Me” page, a “Sweepstakes and Free Stuff” page, and one or more “Find Deals” pages). The incentive management system may also be able to support the addition or subtraction of the above registration data elements from a consumer registration process.

Initial Consumer Registration Pages 502

In the First Name page, consumers' first names may be input via an onscreen keyboard 404. In one embodiment, the “Back” button may not be displayed 410 on the “First Name” page. The consumers may then press the “Next” button 410 to be taken to the “Last Name” page. In the Last Name page, consumers' last names may be input via the onscreen keyboard 404. While on the Last Name page, consumers may press the “Back” button 410 to be taken back to the “First Name” page and/or the “Next” button 414 to be taken to the “Ten-digit Phone Number” page.

In the Ten-Digit Phone Number page, a ten-digit phone number associated with a consumer may be input via an onscreen keyboard. In one embodiment, the Ten-Digit Phone Number page may include a message that encourages the inputting of a cellular phone numbers to receive exclusive benefits and incentive notifications delivered directly to their phones. These ten-digit phone numbers may then be used as the consumer's unique identifier. While in the Ten-Digit Phone Number page, consumers may press the “Back” button to be taken back to the “Last Name” page and the “Next” button to be taken to the “Four-digit PIN” page. In the Four-digit PIN page, a four-digit PIN number may be input via an onscreen keyboard. The four-digit PIN may be used for consumer identification confirmation. While in the Four-digit PIN page, consumers may press the “Back” button to be taken back to the “Ten-digit Phone Number” page and press the “Next” button to be taken to the “Secret Word” page.

In the Secret Word page, a “secret” word may be input via an onscreen keyboard. Secret words may be used by consumers in lieu of the four-digit PIN for consumer identification confirmation at kiosks or other consumer input locations. While in the Secret Word page, consumers may press the “Back” button to be taken back to the “Four-digit PIN” page and/or the “Next” button to be taken to the “Email Address” page. In the Email Address page, consumers' email addresses may optionally be input via an onscreen keyboard. Consumers that choose to provide email addresses may also presented with an option of choosing what kinds emails they wish to receive including either “Thank You” emails or “Email Alerts.” While in the Email Address page, consumers may press the “Back” button to be taken back to the “Secret Word” page and the “Next” button to be taken to the “Text Message Opt-in” page 504.

Text Message Alert Opt-in Page 504

A consumer may opt-in to receive text message alerts via the Text Message Alert Opt-in page 504 utilizing the onscreen keyboard. While in the Text Message Alert Opt-in page 504, consumers may press the “Back” button to be taken back to the “Email Address” page and the “Next” button to be taken to the “Wireless Carrier Identification” page 508.

Wireless Carrier Identification Page 506

The “Wireless Carrier Identification” page 506 allows consumers the option to identify their current wireless carrier by touching its associated onscreen logo (i.e. Verizon Wireless, Cingular, T-Mobile, etc.). Any number of targeted carriers may be displayed on “Wireless Carrier Identification” page. Each carrier identified on “Wireless Carrier Identification” page may have a specific “Wireless Competitive Advantage” page associated with it. Upon selection of their current wireless carrier, the consumer may be taken directly to the associated “Wireless Carrier Competitive Advantage” page(s) 508. While in the “Wireless Carrier Identification” page 506, consumers may press the “Back” button to be taken back to the “Text Message Opt-in” page. Consumers choosing not to respond to the optional identification of current wireless carrier in the “Wireless Carrier Identification” page 506 may press the “Next” button to be taken to the “About Me” page in order to continue the registration process.

Wireless Carrier Competitive Advantage Page(s) 508

As previously stated, each of the wireless carrier choices listed on the “Wireless Carrier Identification” page 506 may have a dedicated “Wireless Carrier Advantage” page that may contain an overview of a preferred carrier's perceived competitive advantage over the consumer's current wireless carrier (e.g., Why Verizon Wireless is better than Sprint). The “Wireless Carrier Advantage” page may also present the consumer with various consumer surveys and incentives. During a survey, a consumer may input responses to the survey via “radio button” responses to questions such as “how many minutes per month do you use your cellular phone?” or “Are most of your cellular calls made to a small group of people?” In on embodiment, dynamically generated incentives may be created based upon the above survey data gathered and then presented to consumers in real-time. As with all incentives, each of the preferred carrier's incentives may have a dedicated “Incentive Details” page. As an option, if the consumer inputs a wireless carrier that is associated with the incentive management system as a preferred carrier, then the consumer may be the Competitive Advantage” page of the preferred carrier so that the consumer may be offered incentives to “re-up” with the preferred carrier. In one embodiment, the “Back” button may not be presented on “Wireless Carrier Competitive Advantage” pages (see FIG. 5). After selecting or not selecting incentives, consumers may press the “Next” button to be taken to the “About Me” page of the Subsequent Consumer Registration pages 510 in order to continue the registration process.

Subsequent Consumer Registration Pages 510

In one embodiment, the subsequent consumer registration pages 510 may include an “About Me” page and one or more “Sweepstakes and Free Stuff” pages. Upon completion of the subsequent consumer registration pages 510, a “Find Deals” page 512 may then be displayed to the consumer. The “About Me” page provides a location where consumers can enter or edit personal information and shopping preferences, such as, for example: system registration information, shopping preferences, personal styles and tastes, personal data and general preferences (e.g., birthday, gender, occupation, marital status/plans, children/ages, rent or own home, hobbies, current make/model of vehicle, favorite make/model of vehicle, favorite brands, favorite color, default preferred language (e.g., English or Spanish)), and communication preferences (e.g., Email Alert Opt-In, Text Message Alert Opt-In, eCirculars Opt-In). In the “About Me” page, consumers may input data via drop-down menus, radio buttons, or other methods that will not involve “free-flow” data input. Using the “About Me” page, a consumer may be able to review and edit the input data and update their data with the system, if necessary. In one embodiment, the “About Me” page may not include a “Back” button. Upon completing the “About Me” page, consumers in the process of registering with the incentive management system may press the “Next” button 512 to be taken to the “Sweepstakes and Free Stuff” page. Existing consumers pressing the “Next” button may be taken directly to the “Find Deals” page (and skip the “Sweepstakes and Free Stuff” page). Consumers that have made changes to any information on the “About Me” screen may be prompted to save changes before exiting the “About Me” page. As an option, existing consumers may access the “About Me page by selecting an “About Me” navigation button displayed as one of the application navigation buttons 416 in the horizontal navigation bar 406 at any time.

The Sweepstakes and Free Stuff page(s) may be displayed to consumers to offer consumers periodic sweepstakes and free incentives and thereby engender participation. If a sweepstakes or interactive game is operational, consumers may be automatically entered into sweepstakes by logging in to any in-mall kiosk, in-store kiosk, or POS card device. In such an embodiment, qualifying messages (e.g., “You must be twenty-one years of age to participate . . . ”) may be displayed with additional instructions for non-qualified consumers. Consumers may access detailed information regarding the rules and regulations of the sweepstakes by pressing a “Sweepstakes Rules” button displayed on the “Sweepstakes and Free Stuff” page. In one embodiment, the “Sweepstakes and Free Stuff” page may have a link to the “Text Message Alert Opt-in” and “Email Alert Opt-in” pages. From the Sweepstakes and Free Stuff page, consumers then press the “Next” button to be taken to a “Find Deals” page 512. Existing consumers may access the Sweepstakes and Free Stuff page by selecting the “Sweepstakes and Free Stuff” navigation button displayed as one of the application navigation buttons 416 in the horizontal navigation bar 406 at any time.

Find Deals Page 512

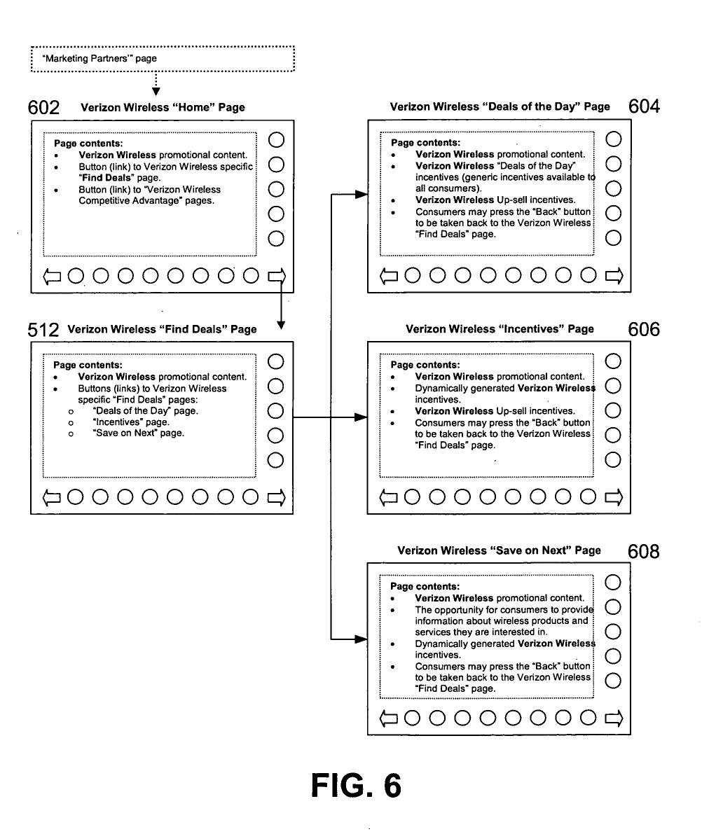

As previously discussed, a retailer's Find Deals page 512 may be accessed via selection of the Find Deals button 416a of the horizontal navigation bar 406 or by selection of the marketing partner's button 418. FIG. 6 is a block diagram illustrating a linking of pages associated with a Find Deals page 512 via selection of a marketing partner's button 418 in accordance with an embodiment. Upon selection of the marketing partner's button 418, the consumer is presented with a page 602 associated with the marketing partner in the incentive manager system. The “Marketing Partners” bottom may include a logo of the marketing partner to enable a consumer to easily identify the marketing partner. This page 602 may be referred to as the marketing partner's home page in the incentive manager system. In one embodiment, the home page 602 may include promotional content of the marketing partner, a link to the Find Deals page A412 of the marketing partner and a link to the Competitive Advantage page of the marketing partner.

As shown in the embodiment illustrated in FIG. 6, the “Find Deals” page 512 may generally include links to three associated pages including: a “Deals of the Day” page 604, an “Incentive Selection” page 606, and a “Save on Next” page 608. Existing consumers may access this page by pressing a “Find Deals” navigation button 416a displayed on a horizontal navigation bar 406 at any time. Consumers pressing the “Next” button from a Find Deals page 512 may be taken to a “Cross-Sell” page if there are applicable “cross-sell” incentives available to them. If there are no applicable “cross-sell” incentives available, consumers may return be taken to a “Marketing Partners” page that displays links to a plurality of marketing partners of the incentive management system. In the Find Deals pages, consumers are presented incentives that the consumers may then select by clicking on the displayed incentive. In one embodiment, consumers may press the “Go!” button 414 to save selected incentives to their account or to their cards and exit the application. In one embodiment, a “Marketing Partners” page may be accessed by consumers from any page using a marketing partner button 408 that displays the name or logo of the marketing partner. In one embodiment, all of the “Find Deals” pages 512, 604, 606, 608 may include links to “Text Message Alert” opt-in and “Email Alert” opt-in pages (see FIG. 5).

Deals of the Day Page 604

“Deals of the Day” are incentives on specific products retailers and marketing partners would like to showcase. “Deals of the Day” incentives may be generic incentives available to all consumers. Multiple “Deals of the Day” incentives for selection by a consumer may be displayed on the “Deals of the Day” page 604. After selecting or not selecting “Deals of the Day” incentives, consumers may press either the “Next” button or the “Back” button to be taken back to the “Find Deals” page 512. Consumers may press the “Go!” button 414 to save selected incentives to their account with the incentive management system and exit the application.

Incentive Selection Page 606

While multiple incentives may appear on a single page (i.e. “Incentive Selection” page 606), each incentive may have its own “Incentive Detail” page 606. Consumers access an “Incentive Detail” page 606 by pressing the onscreen image of an incentive displayed on the Find Deals page 512, Deals of the Day page 604 or other Incentive Detail page 606.

Retailers may offer as many in-mall and in-store incentives as they like. In-store kiosks may display marketing partners' promotional content, including retailer-specific promotional content and retailer-specific incentives (same content as retailer “Home” pages 602). Consumers begin navigation of incentive pages 606 by selecting one of the following incentive groups: 1) Personal recommendations, 2) product category, 3) specific retailer, 4) most popular, 5) gift reminder recommendations, or 6) all available incentives. Consumers navigate through multiple-page incentive groups via general navigation buttons (“page 1 of 3”) located within the “Page Content Area” 402 of an incentive page 606.

An individual incentive may be placed in multiple categories. Incentives are not necessarily limited to the “Incentive Selection” page and may be placed on any page.

One or more of the “Incentive Selection” pages 606 may have links to the “Text Message Alert Opt-in” and “Email Alert Opt-in” pages (see elements 502, 504). After selecting or not selecting incentives, consumers may press either the “Next” button or the “Back” button to be taken back to the main “Find Deals” page 606. Consumers may press the “Go!” button to save selected incentives to their accounts and to exit the application.

Save on Next 608

The “Save on Next” page 608 is where consumers can provide information about products they are interested in by pressing one or more category buttons displayed in the “Save on Next” page 608. Some exemplary categories for the Save on Next page 608 (designed to match incentive creation criteria) may include: Top-level category (e.g. “Mens,” etc.), Product level category (e.g. “Apparel,” etc.), Product sub-category (e.g. “Casual clothing, ” etc.), and Product item category (e.g. “Sweaters,” etc.). Consumers may select a “Done” button displayed on the “Save on Next” page 608 when finished to save selections.

Current incentives that match the “product item category” of the Save on Next 608 page may be presented to the consumer immediately. Future incentives matching consumers' “Save on Next” criteria may be placed in the “Personal Recommendations” section of the “Incentive Selection” page. The “Save on Next” page may also have a link to the “Text Message Alert Opt-in” and “Email Alert Opt-in” pages. After selecting or not selecting “Save on Next” incentives, consumers may press either the “Next” button or the “Back” button to be taken back to the “Find Deals” page. Consumers may press the “Go!” button to save selected incentives to their account and exit the application. In one embodiment, consumers may press a “Save on Next” button (link) displayed in the horizontal application navigation bar 406 at any time to access the “Save on Next” page 608.

Cross-Sell Incentives Page

Consumers that are eligible for cross-sell incentives (for instance, redemption of a DaimlerChrysler incentive “activates” a Foot Locker incentive) may be taken from the “Find Deals” page to a “Cross-Sell Incentives” page. “Cross-sell” incentives may have a plurality of associated up-sell incentives. The “Cross-sell Incentives” page may include a link to the “Text Message Alert Opt-in” and “Email Alert Opt-in” pages. After selecting or not selecting “cross-sell” incentives displayed on the Cross-Sell Incentives page, consumers pressing the “Next” button will be taken to the “Marketing Partners” page while consumers pressing the “Back” button will be taken back to the “Find Deals” page. Consumers may press the “Go!” button to save selected incentives to their accounts and exit the application.

Marketing Partners Page(s)

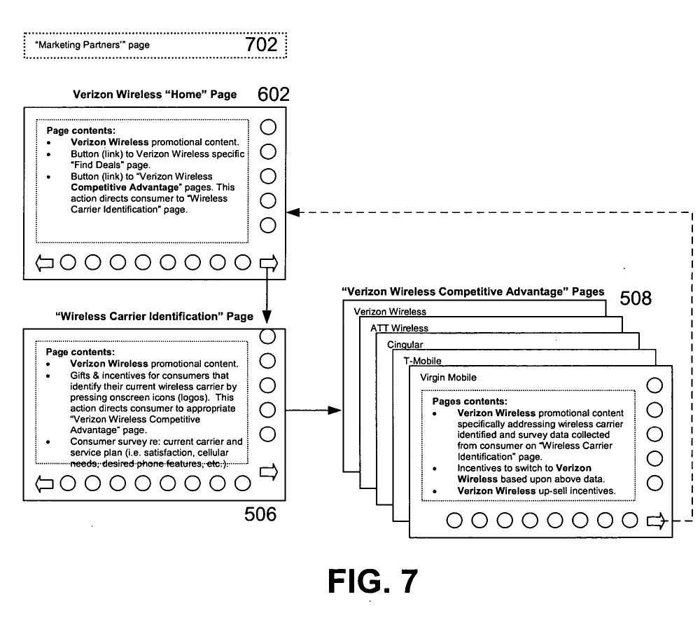

FIG. 7 is a schematic block diagram illustrating a relationship between a marketing partner's home page in an incentive managing system to a Competitive Advantage page of the marketing partner in accordance with one embodiment. As previously discussed, a dedicated area of the vertical navigation bar 408 may display rotating logos of one or more marketing partners 418 (e.g., DaimlerChrysler) that serve as a link to the “Marketing Partners” page 702. Each marketing partner may be represented on the “Marketing Partners” page by their logo, which may serve as a link to a “Home” page (e.g., page 602) in the incentive management system associated with that company. The dedicated “Marketing Partners” pages may include an “Home” page 602, an Identification page 506, “Find Deals” pages 512 (see FIG. 5) and “Competitive Advantage” page(s) 508.

Marketing Partners Home Page 602

Each marketing partner may have an associated “Home” page 602 in the incentive management system that contains partner-specific promotional content and links to the partner's “Find Deals” and “Competitive Advantage” pages 512, 508. When in the Home page 602, consumers pressing the “Next” button 412 will be taken to a “Cross-Sell” page if there are applicable “cross-sell” incentives available to them. If there are no applicable “cross-sell” incentives available to consumers, then the consumers will be taken to a “My Deals” page. When on the Home page 602, consumers may press the “Go!” button 414 to save selected incentives to their account in the incentive management system and exit the application.

Marketing Partners Find Deals Page(s) 512

As previously discussed, a marketing partners' “Find Deals” page 512 may include three portions including: a “Deals of the Day” page 604, an “Incentive Selection” page 606, and a “Save on Next” page 608. When on any of the Find Deals pages 512, 604, 606, 608, consumers may press either the “Next” button 412 or the “Back” button 410 to be taken back to the marketing partner's “Home” page 602. Like the other pages, consumers may press the “Go!” button 414 when on this page 512 to save selected incentives to their accounts and exit the application.

Deals of the Day Page 604

A Deals of the Day page 604 displays Deals of the Day incentives for selection by a consumer. Marketing partners' “Deals of the Day” incentives possess the same attributes as all other “Deals of the Day” incentives, except that “Deals of the Day” incentives may be exclusive to this particular marketing partner. Marketing partners' “Deals of the Day” pages 604 may include links to the “Text Message Alert Opt-in” and “Email Alert Opt-in” pages. After selecting or not selecting “Deals of the Day” incentives, consumers may press either the “Next” button or the “Back” button displayed in the horizontal navigation bar of the “Deals of the Day” page 604 to be taken back to the marketing partner's “Find Deals” page 512. Consumers may press the “Go!” button 414 to save selected incentives to their accounts and exit the application.

Incentive Selection Page 606

An Incentive Selection page 606 displays general incentives for selection by a consumer. Marketing partners' general incentives possess the same attributes as all other incentives, except these may be exclusive to this particular marketing partner. Consumers begin navigation of marketing partners' incentive pages 606 much like all other incentives, by selecting one of the following incentive groups: 1) Personal recommendations, 2) product category, 3) most popular, 4) gift reminder recommendations, or 5) all available incentives. Marketing partners' “Incentive Selection” pages may include links to the “Text Message Opt-in” and “Email Alert Opt-in” pages. After selecting or not selecting incentives, consumers may press either the “Next” button or the “Back” button to be taken back to the marketing partner's “Find Deals” page. Consumers may press the “Go!” button to save selected incentives to their accounts in the incentive management system and exit the application.

Save on Next Page 608

Displayed on a Save on Next page 608 are a marketing partner's “Save on Next” incentives possess the same attributes as all other “Save on Next” incentives, except these are exclusive to this particular marketing partner. A marketing partner's “Save on Next” pages may include links to the “Text Message Opt-in” and “Email Alert Opt-in” pages. After selecting or not selecting “Save on Next” incentives, consumers may press either the “Next” button or the “Back” button to be taken back to the marketing partner's “Find Deals” page. Consumers may press the “Go!” button to save selected incentives to their accounts in the incentive management system and exit the application.

Marketing Partners Competitive Advantage Page(s) 508

A marketing partner's “Competitive Advantage” page 508 may contain an overview of the marketing partner's perceived competitive advantages (i.e. Why American Express Blue is the card is superior to Visa). A Marketing partner's “Competitive Advantage” page 508 may also contain consumer surveys. Consumer survey data may be input via “radio button” responses to questions such as “Are you currently an American Express customer?” or “Would you like to save 5% on your purchases every time you shop?” Dynamically generated incentives may then be created based upon the gathered survey data. Consumers may press either the “Next” button or the “Back” button from the marketing partner's “Competitive Advantage” page 508 to be taken back to the marketing partner's “Home” page 602. Consumers may press the “Go!” button 414 from the marketing partner's “Competitive Advantage” page 508 to save selected incentives to their accounts and exit the application.

In one embodiment, a Marketing Partners” page 602 may be accessed by consumers from any page. Similarly, in another embodiment, a “Find Deals” page\ may include links to “Text Message Alert” opt-in and “Email Alert” opt-in pages. Dynamically generated incentives may further generated for specific consumers based upon survey data gathered and “Save on Next” responses.

My Deals Page

A “My Deals” page may be accessed utilizing the “My Deals” navigation button 416b displayed in the horizontal navigation bar 406. A “My Deals” page is associated with a consumer's account in the incentive management system. Actions, such as selections and other input, by the consumer while accessing the My Deals page may be stored in an entry associated with the consumer's account in a database of the incentive management system. A “My Deals” page may display all incentives selected by consumers, either in-store or on-line. The “My Deals” page may also display a plurality of up-sell incentives for each selected incentive. Consumers may select up-sell incentives from their “My Deals” by selecting them in the same way they select incentives displayed the “Incentive Selection” page. The “My Deals” page may include links to the “Text Message Opt-in” and “Email Alert Opt-in” pages. Consumers may press the “Next” button or the “Back” button from the “My Deals” page to return to the “Find Deals” page or press the “Go!” button to save selected incentives to their account and exit the application. In one embodiment, existing consumers may access their associated My Deals page by selecting the “My Deals” navigation button 416b at any time after login.

Gift Reminder Page

A “Gift Reminder” page may be accessed utilizing the “Gift Reminder” navigation button 416e displayed in the horizontal navigation bar 406. The “Gift Reminder” page is where consumers may input gift-giving occasions and associated dates. Standard events in the “Gift Reminder” program may include, for example: Valentine's Day, Father's Day, Grandparent's Day, Sweetest Day, Mother's Day, Administrative Professionals' Day (formerly Secretaries Day), and Bosses' Day. Consumers may have the option of adding other customized dates to their “Gift Reminder” page. Customized gift reminder dates include the following input fields: Occasion, Date (month, date), Relationship with recipient (optional), and product category information (e.g., top-level category (e.g. “Mens,” etc.), product level category (e.g. “Apparel,” etc.), product sub-category (e.g. “Casual clothing, ” etc.), product item category (e.g. “Sweaters,” etc.)), notification date and time (specifying when to notify the consumer prior to the gift occasion), and notification type (email, text message, etc). Gift recommendations and incentives may appear in a “Gift Reminder Recommendations” section of the “Incentive Selection” page 606. The “Gift Reminder” page may also include links to the “Text Message Opt-in” and “Email Alert Opt-in” pages. Consumers may press the “Next” button or the “Back” button from the “Gift Reminder” page to return to the “Find Deals” page and may press the “Go!” button to save selected incentives to their account and exit the application. In addition, existing consumers may access the Gift Reminder page by selecting the “Gift Reminder” navigation button 416e any time after login.

Consumer Comment Card Page

A “Consumer Comment Card” page may be provided to provide a location for consumers to provide feedback on their shopping experiences to either the mall or to a particular retailer. Upon accessing the “Consumer Comment Card” page, consumers may be queried to press an onscreen logo of the retailer for which the feedback is intended. If the feedback is intended for a mall, consumers may be presented with a logo associated with the mall. This action takes the consumer to an associated “Consumer Comment Card” page for either the mall or a particular retailer. Consumers may be able to input the following data on comment cards via drop-down menus, radio buttons, or other methods that will not involve “free-flow” data input: overall satisfaction with visit, speed of service, pleasantness of staff, and “Would you like a manager to contact you?” (if consumer has provided email address). The incentive management system may support the addition or subtraction of the above comment card fields.

“Consumer Comment Card” feedback may then be forwarded directly from the incentive management system to a dedicated email addresses for either the mall's or retailer's customer service departments. Consumers that have provided their email addresses to incentive management system may also request to receive a reply from either the mall or the retailer to which the feedback is addressed. Existing consumers may access this page by pressing the “Consumer Comment Card” navigation button 416f at any time after login. From the Consumer Comment Card page, consumers may press the “Back” button to be taken to the “Find Deals” page.

Help Page

Consumers may select the “Help” button 416g to access a “Help” page. The “Help” page may include sections for providing General assistance and helpful hints for each page, FAQ'S, How do I?, terms of privacy policy, and Instructions on contacting customer service. Consumers may press the “Next” button or the “Back” button from the “Help” page to be returned to the page from which the “Help” page was accessed. Existing consumers may access this page by pressing the “Help” navigation button 416g at any time after login.

Retailer Home Page

Each retailer in the incentive management system may have an associated “Home” page 602 that contains retailer-specific promotional content and a link to retailer-specific “Find Deals” pages 512. Consumers pressing the “Next” button from a retailer home page may be taken to the “Cross-Sell” page if there are applicable “cross-sell” incentives available to them. If there are no applicable “cross-sell” incentives available to consumers, they will be taken to a “My Deals” page. From the retailer home page 602, consumers may press the “Go!” button to save selected incentives to their account maintained by the incentive management system and exit the application.

Find Deals Page(s)

A retailer's “Find Deals” page comprises a plurality of sections including a “Deals of the Day” page, an “Incentive Selection” page, and a “Save on Next” page. Like the other Find Deals pages 512, consumers may press either the “Next” button or the “Back” button to be taken back to the retailer's “Home” page and consumers may press the “Go!” button to save selected incentives to their accounts and exit the application.

Deals of the Day Page

Retailer-specific “Deals of the Day” incentives possess the same attributes as all other “Deals of the Day” incentives, except these may be exclusive to this particular retailer. Retailer-specific “Deals of the Day” pages may include links to the “Text Message Opt-in” and “Email Alert Opt-in” pages. After selecting or not selecting “Deals of the Day” incentives, consumers may press either the “Next” button or the “Back” button to be taken back to the retailer's “Find Deals” page or, press the “Go!” button to save selected incentives to their account and exit the application.

Incentive Selection Page

Retailer-specific incentives possess the same attributes as all other incentives, except these may be exclusive to this particular retailer. Consumers begin navigation of retailer-specific incentive pages much like all other incentives, by selecting one of the following incentive groups: 1) Personal recommendations, 2) product category, 3) most popular, 4) gift reminder recommendations, or 5) all available incentives. Retailer-specific “Incentive Selection” pages will have links to the “Text Message Opt-in” and “Email Alert Opt-in” pages. After selecting or not selecting incentives, consumers may press either the “Next” button or the “Back” button to be taken back to the retailer's “Find Deals” page or may press the “Go!” button to save selected incentives to their accounts and exit the application.

Save on Next Page

Retailer-specific “Save on Next” incentives possess the same attributes as all other “Save on Next” incentives, except these are exclusive to this particular retailer. Retailer-specific “Save on Next” pages may include links to the “Text Message Opt-in” and “Email Alert Opt-in” pages. After selecting or not selecting “Save on Next” incentives, consumers may press either the “Next” button or the “Back” button to be taken back to the retailer's “Find Deals” page or press the “Go!” button to save selected incentives to their accounts and exit the application.

POS Devices

Consumers interact with the incentive management system at the retailer's point-of-sale (POS) by inserting their cards into a point of sale card reading device and then entering their 4-digit PIN. In one embodiment, the POS card reading devices may have wireless connectivity. In an enhanced security embodiment, consumers may not redeem incentives at the point-of-sale without their cards. In another embodiment, the consumer may be permitted to redeem incentives at a point of sale without their cards by simply providing their telephone number and PIN at the point of sale.

The POS card reading device then reads data directly from the card and displays the consumer's name and relevant coupon data for that particular store—including incentive description, value and SKU—onscreen. More than one incentive may be available to consumers at the same time. Each incentive may be numbered on the POS card reading device's display (i.e. 1, 2, 3 . . . ) for easy identification. Consumers then select from the displayed incentives the incentives that they wish to redeem by pressing their associated number from above (i.e. 1, 2, 3 . . . ) on the keypad of the POS card reading device. This “highlights” the incentive in order to make it easier for the retailer's cashier to identify. Cashiers read the Promo Code of each incentive directly from the POS card reading device's screen, and then manually enter the code into the retailer's POS system (i.e. cash register) as part of the checkout process (just as they would with a paper coupon). The POS system may then be utilized to reconcile incentives with product purchases to determine which incentives to redeem (again, just as they would with a paper coupon). To finalize the transaction, the cashier may simply presses an “Accept” button displayed on the POS card reading device's screen. This action ejects the consumer's card, as may be required in a smart card embodiment, and resets the POS card reading device for the next transaction. The POS card reading device may automatically transmit transaction data back to the incentive management system.

Online Consumer

Consumers may also be able to access the incentive management system from outside physical malls and retail stores (i.e. web sites, emails, eCirculars, etc.) via a secure log-on process consisting of inputting their unique consumer identifier and 4-digit PIN. Consumers accessing the incentive management system via a mall's web site may have access to the same content available on in-mall kiosks. Similarly, consumers accessing the incentive management system via a retailer's web site may also have access to the same content available on in-store kiosks. Consumers may view the same promotional content and select the same incentives online as they would on an in-mall or in-store kiosk. Incentives selected online may be posted to consumer's “My Deals,” just as they would on an in-mall or in-store kiosk. In a smart card embodiment, consumers selecting incentives online may be instructed to “re-load” their smart cards with newly selected incentives by inserting the cards into any Interactive Kiosk.

Retailer Web Portal

Each retailer may have a customized web portal to use to manage its account in the incentive management system. Retailers may access their web portals via a secure log in process from a web site of the incentive management system. As an option, retailers may provide employees with multiple levels of system privileges for management and reporting purposes. For example, the following are available levels of system privileges: (1) Retail employee (ability to finalize transactions on POS devices); (2) Retail store manager (ability to view reports); and (3) Retail administrator (ability to view reports and add or edit employee information at multiple store locations).

Retailer Web Portal may contain at least four sections, including: (1) a “How do I?” section; (2) a “Statistics Snapshot” section; (3) an “Upload Transaction Logs” section; and (4) a “Customer Service” section.

How do I? Section

The “How do I” section of the web portal is where retailers have access to the following automated support functions: (1) FAQ's; (2) On-line Tutorials; and (3) On-line tutorials must be created for every retailer function in the incentive management system.

Statistics Snapshot (Report Generator) Section

The statistics snapshot section of the retailer web portal may include a report generator for generating a plurality of reports on various aspects and metrics arising in the incentive management system. Reports may be generated for incentive performance, outbound marketing campaigns, marketing data collection, and kiosk performance.

Incentive Performance Reports

Utilizing the report generator of the statistics snapshot section of a retailer web portal in the incentive management system, retailers may be able to generate a variety of reports regarding digital incentives. Some exemplary incentive performance reports may include reports regarding: (1) the number and percentage of consumers selecting particular incentives; (2) the number and percentage of consumers selecting up-sell incentives; (3) the number and percentage of consumers redeeming incentives; and/or (4) the total revenue generated by participating consumers (if retailer's transactional data is shared). The report generator may also include features for permitting a retailer to segment an incentive performance report by: (1) employee ID, date and time of incentive selection; and/or (3) a date and time of incentive redemption. The report generator may also be capable of providing multi-store retailers the ability to segment these reports by individual stores or groups of stores. As an option, incentive performance reports may be generated on both current and past incentives utilizing the report generator.

Outbound Marketing Campaigns Reports

Utilizing the report generator of the statistics snapshot section of a retailer web portal in the incentive management system, retailers may be able to generate reports regarding outbound marketing campaigns (eCircular and text messaging). These reports may include information relating to: (1) a total number of eCirculars or text messages launched; (2) “click rates” of consumers viewing eCircular campaigns; (3) the number and percentage of consumers selecting primary incentives from campaigns; (4) the number and percentage of consumers selecting up-sell incentives from campaigns; (5) the number and percentage of consumers redeeming incentives; (6) additional in-mall or in-store incentives and up-sell incentives selected by consumers responding to campaign; and/or (7) the total revenue generated by campaign (if retailer's transactional data is shared). Like the other reports, the report generator should provide multi-store retailers with the ability to segment these reports by individual stores or groups of stores. Marketing campaigns and included incentives may also be able to be compared to effectively “dial in” highest level of marketing performance (e.g., Do various text message coupon expiration dates produce different redemption rates?). Like the other reports, outbound marketing campaign reports may be generated on both current and past campaigns.

Marketing Data Collection Reports

Utilizing the report generator of the statistics snapshot section of a retailer web portal in the incentive management system, retailers may be able to access marketing data collected, such as: (1) consumer “wish list” data collected via the “Save on Next” page and/or (2) consumer feedback.

Kiosk Performance Reports

Utilizing the report generator of the statistics snapshot section of a retailer web portal in the incentive management system, retailers may be able to access performance statistics for each in-store kiosk (if applicable), and compare kiosks so that the utility of each is maximized. For instance, if one kiosk has less consumer activity than others within the same store, it can be placed elsewhere within the store so that it is more effective.

Customer Service Section

The “Customer Service” area of the retailer web portal may allow retailers to contact the incentive management system provider via email for application support, in-store kiosk support (if applicable), POS device support, suggestions, and requests. For urgent matters, retailers may also have the option of contacting the incentive management system provider via telephone.

Incentive Management System Administrative Web Portal

The incentive management system may include an administrative web portal for permitting an incentive management system provider a portal for conducting administrative functions of the incentive management system. The administrative portal may include: (1) a retailer profile administrative area; (2) a marketing tool administrative area; and/or (3) a mall marketing functions administrative area.

Retailer Profile Administrative Area

The “Retail Store Profile” area of the Administrative web portal is where support staff of the incentive management system may edit and update retail store information such as, for example: retailer (or “store”) name; primary store information (e.g., store address (address line, city, state (standard abbreviation), zip code (five and nine number, same space)), primary business address (if different than above), telephone number(s), fax number(s), current web site address (if applicable), managers' names, managers' phone numbers (store and cellular), and managers' email addresses); store hours; key employee names and system privileges; and/or product information (i.e. UPC's and SKU's).

Each retail store may be assigned a unique retailer ID number for use in the incentive management system for identifying the retailer. Multi-store retailers may group individual stores (i.e. divisions, regions, etc.) for management and reporting purposes. Retailers' individual product identifiers (UPC's or SKU's) may also be used as unique product ID numbers in the incentive management system. Retailers may categorize and group unique product ID numbers in the incentive management system in order to classify products as “complimentary” for use in creating up-sell incentives. Retailers may also assign designated staff members to handle consumer feedback, and provide the incentive management system with email addresses to which feedback from consumers will be directed.

Marketing Tools Administrative Area

The marketing tools administrative area may include tools for permitting an administrator (or even a retailer) of the incentive management system the ability to create new incentives, manage existing incentives, generate “Thank You” emails, create email alerts, create and manage eCircular campaigns, and create and manage text message campaigns.

Create New Incentives Tool

Generic Incentives

The marketing tools administrative area may include a “Create New Incentives” tool where new generic incentives are created using either a “New Incentive Builder Wizard,” or drawing from a library of previously created incentive templates. Incentives may include the following items: incentive category (e.g. “Bounce-back”), unique incentive ID (Promo Code), top-level category (e.g. “Mens,” etc.), product level category (e.g. “Apparel,” etc.), product sub-category (e.g. “Casual clothing, ” etc.), product item category (e.g. “Sweaters,” etc.), incentive “offer” (e.g. “save $10”), incentive description (e.g. “All Alfani sweaters in-stock”), incentive image, retailer product SKU, incentive start date (MM/DD/YYYY), incentive end date (MM/DD/YYYY), and incentive “qualifiers.” Incentive qualifiers may include: valid days, if applicable (Sunday-Saturday and any combination in-between), incentive start time (optional), incentive end time (optional), and incentive requirements (N/A for always, visit number, purchase number, e-mail sent date). In one embodiment, incentives may be mutually exclusive (e.g. not available with other offers) and may be either transferable or non-transferable to other consumers.

Using the create new incentives tool, consumer incentives may also be scheduled for specific periods of time (i.e. specific starting and ending dates and times), recurring periods of time (i.e. every Wednesday) or as an on-going incentive (i.e. specific starting dates and no specific end dates).

Manage Existing Incentives Tool

The marketing tools administrative area may include a “Current Incentives” section of the web portal where existing incentives may be viewed, modified or deleted. Deletion of a primary incentive may also delete any associated “up-sell” incentives. Modification of a primary incentives' expiration date, times, or frequency may also modify those of associated “up-sell” incentives.

“Thank You” Emails Tool

The marketing tools administrative area may include a tool for generating post-sale “Thank You Emails” on a same-day basis for consumers that redeem incentives within participating retail stores. Those retailers with whom the consumer redeems incentives will be represented on the email. “Thank You Emails” may be generated to include: Thank you wishes, Opportunity to provide feedback on consumer's shopping experience via link to “Consumer Comment Card” page, “Bounce-back” incentives, a link to a “Save on Next” page, a link to a “My Deals” page, links to participating retailers' web sites, and/or promotional content from marketing partners. Consumers may be able to select incentives directly from the email by “clicking” on them. This will activate the consumer online log-in process, which is input of the consumer's unique consumer ID and 4-digit PIN. After logging in to incentive management system, consumers may be directed to that incentive's “Incentive Detail” page.

Email Alerts Tool

The marketing tools administrative area may include a tool for launching “Email Alerts” to consumers that opt in to receive them. An Email Alert campaign may include: eCircular alerts; promotional campaigns; incentive expiration reminders; gift reminder notifications, and “Save on Next” product item category incentive matches.

An “Email Alert” may include: promotional content, digital incentives, links to a “Save on Next” page, a “My Deals” page and participating retailers' web sites (if applicable).

As with “Thank You Emails,” consumers may select incentives directly from “Email Alerts” by “clicking” on them. This will activate the consumer online log-on process, which is input of the consumer's unique consumer ID and 4-digit PIN. After logging in to incentive management system, consumers may be directed to the online “Incentive Selection” screen. The selected incentive (from the email) should already be selected (highlighted) and associated up-sell incentives onscreen.

eCircular Campaigns

Periodic eCircular marketing campaigns may be launched to consumers that have opted in to receive them. eCirculars are “delivered” to consumers as emails. “Clicking” on the eCircular activate the consumer online log-on process, which inputs the consumer's unique consumer ID and 4-digit PIN into the system. After logging in to the incentive management system, consumers may be directed to a dedicated “eCircular” section of the web site.

eCircular Page Layout Tool

The marketing tools administrative area may include an eCircular page layout tool for creating eCirculars. The design and promotional content of eCirculars may reflect that which would be presented to individual consumers on an in-mall kiosk. The layout tool for creating eCircular pages may be “framed” by a navigation bar so the following navigation buttons (links) are always available to consumers (after logging on to incentive management system): “Find deals” (link to page), “My Deals” (link to page), “About Me” (link to page), “Sweepstakes and Free Stuff” (link to page), “Gift Reminder” (link to page), “Help” (link to page), “Back” (button to move backward in application), “Next” (button to move forward in application) and “Go!” (button to post selected incentives to consumers' “Shopping Lists” and exit application). A dedicated area of the navigation bar may display rotating logos of marketing partners (i.e. Verizon Wireless) that serve as a link to the “Marketing Partners” page. The largest portion of the kiosk pages, contained within the aforementioned frame, is where specific web pages will appear. As with “Thank You Emails” and “Email Alerts,” consumers may select incentives directly from “eCirculars” by “clicking” on them.

Text Message Campaigns Tool

The marketing tools administrative area may include a tool for creating and managing text message campaigns. This tool should be able to export data to 3rd party service providers for outbound text message marketing purposes. Incentives may be created for all consumers included in text messaging campaigns, and placed in their respective “My Deals” automatically before the messages are launched. Outbound text message marketing campaigns may include: eCircular alerts, promotional notifications that include incentives for specific products, incentive expiration reminders, gift reminder notifications, “Save on Next” product item category incentive matches, and “My Deals” deliveries. The text message campaigns tool may also be capable of importing data from these 3rd party service providers in order to allow consumers to select incentives remotely using text messages. Incentives may be created for these consumers and placed in their respective “My Deals.”

Mall Marketing Functions Administrative Area

The “Shopping Mall Functions” area of the Administrative web portal is where mall-sponsored consumer incentive programs may be created. Mall-based consumer incentive programs may include, for example: valet parking incentives, Kiddy Kruzzer rental incentives, and so on. In one embodiment, mall sponsored incentives may be classified as primary incentives. In another further embodiment, mall sponsored incentives may not have up-sell incentives. Mall sponsored incentives may be posted to consumers' “My Deals” pages and may also be placed in a “Personal Recommendations” section of the “Incentive Selection” page.

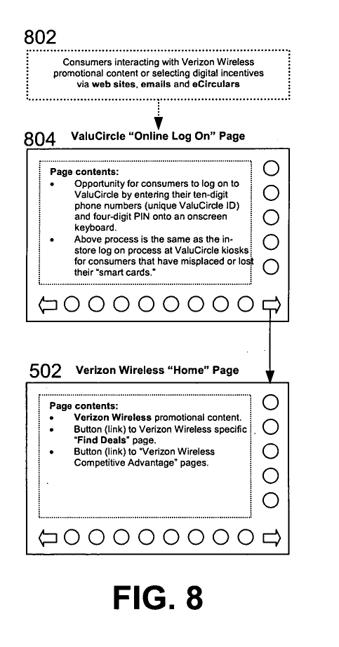

FIG. 8 is a schematic block diagram illustrating a log in process for accessing a marketing partner/retailer home page in an incentive management system in accordance with one embodiment. As shown in FIG. 5, consumers interact with promotional content associated with a marketing partner or retailer via a website, an email or eCircular (see element 802). The promotional content includes a link that upon selection by the consumer directs the consumer to a login page 804 in the incentive management system that is associated with the marketing partner/retailer. Login to the incentive management system by consumer may be accomplished as previously discussed by entering the consumer's ten-digit identifier and four digit PIN. Once the login process is completed, the consumer is then directed to the home page 602 in the incentive management system that is associated with the marketing partner.

Text Messaging

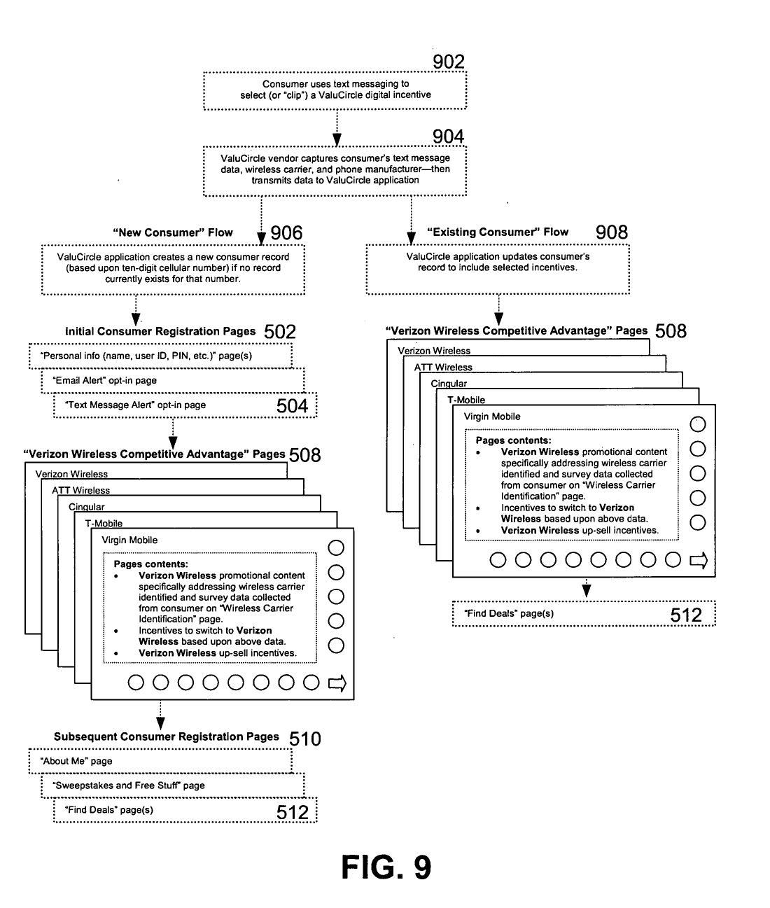

FIG. 9 is schematic block diagram illustrating inbound text messaging paths to a marketing partner/retailer page in an incentive management system in accordance with one embodiment. An incentive is presented to a consumer either via a text message sent to consumer by the incentive management system or via other media such as, for example, a print advertisement. The consumer then uses a text messaging feature of a text messaging enable device (e.g., a mobile phone with text messaging capability) to select the incentive (see element 902). This may be accomplished by the user inputting an identifier associated with the incentive. A text messaging provider or vendor receives the consumer's text messages and forwards it to the incentive management system manager (see element 904). If the consumer is a new user of the incentive management system, a new consumer path 906 is followed. On the other hand, if the consumer is a prior user of the incentive management system, an existing consumer path 908 is followed.

Under the new consumer path 906, the consumer is registered with the incentive management system in a process such as the one set forth in FIG. 5. Under the new consumer path 906, the incentive management system creates a new consumer record an associates a consumer identifier (e.g., a ten-digit telephone number) with the record (see element 906). The new consumer is then presented the initial consumer registration pages 502 including the text message alert opt-in page 504. The new consumer may then be directed to a marketing partner's competitive advantage page(s) 508 and then to the subsequent consumer registration pages 510 and then to the Find Deals page(s) 512.

Under the prior user path A0080, the incentive management system updates the consumer's account in the database of the incentive management system so that the information in account reflects the consumer's selection of the incentive via text messaging. The consumer is then presented with the competitive advantage page(s) 508 and Find Deals page(s) 512 as previously discussed.

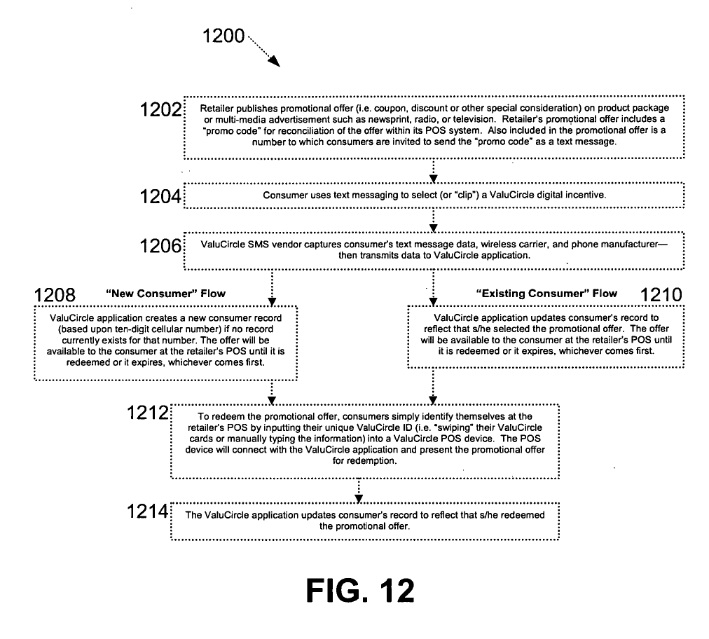

FIG. 12 is a flowchart of a process 1200 for using a text messaging to select digital incentives in accordance with an embodiment of the digital incentive management system. Selecting digital incentives may also be referred to a “clipping coupons.” In operation 1202, a retailer may publish a promotional offer (i.e., a coupon, discount or other special consideration) on a product's packaging or multi-media advertisement such as newsprint, radio, or television. The retailer's promotional offer may include a “promo code” for reconciliation of the offer within its POS system. Also included in the promotional offer is a contact number (e.g., telephone number) to which consumers are invited to send the “promo code” as a text message. In operation 1204, a consumer may then use text messaging to select (or “clip”) a digital incentive by transmitting the promo code to the contact number. In operation 1206, a SMS vendor in communication with the digital incentive manager captures the consumer's text message data and, as a further option, information about the consumer's wireless carrier and/or phone manufacturer, and then transmits data to the digital incentive manager.

If the consumer is a “new consumer” (i.e., a consumer that does not yet possess a unique ID with the digital incentive management system), then in operation 1208, the digital incentive manager registers the new consumer with the digital incentive system and creates a new consumer record (e.g., .that may be based upon ten-digit cellular number associated with the consumer) if no record currently exists for that number. In one embodiment, the consumer registration process may takes place on a web site associated with the digital incentive manager (available to consumers either from kiosks within physical malls or retail stores, or from online). The offer will then be available to the consumer at the retailer's POS until it is redeemed or it expires, whichever comes first. As an option under the “New Consumer Flow” of operation 1208, the “Text Message Alert” opt-in page may be included in the system registration flow because, even though the consumer has sent an inbound text message, the consumer has yet to opt in to receive outbound text messages. As a further option under the “New Consumer Flow” of operation 1208 the “Wireless Carrier Identification” page may be eliminated because the incentive manager may be made aware of the consumer's wireless carrier based on the information provided by the SMS vendor.

If the consumer is an “existing consumer” (i.e., a consumer that already possesses a unique ID with the digital incentive management system), then in operation 1210, the digital incentive manager may update consumer's record to reflect that consumer selected the promotional offer. The offer will then be available to the consumer at the retailer's POS until it is redeemed or it expires, whichever comes first.

To redeem the promotional offer, consumers may identify themselves at the retailer's POS by inputting their unique ID (i.e. “swiping” their digital incentive management system cards or manually typing the information) into a POS device of the digital management system in operation 1212. The POS device may then connect with the digital incentive manager via a network and present the promotional offer for redemption. In operation 1214, the digital incentive manager may update the consumer's record to reflect that the consumer has redeemed the promotional offer.

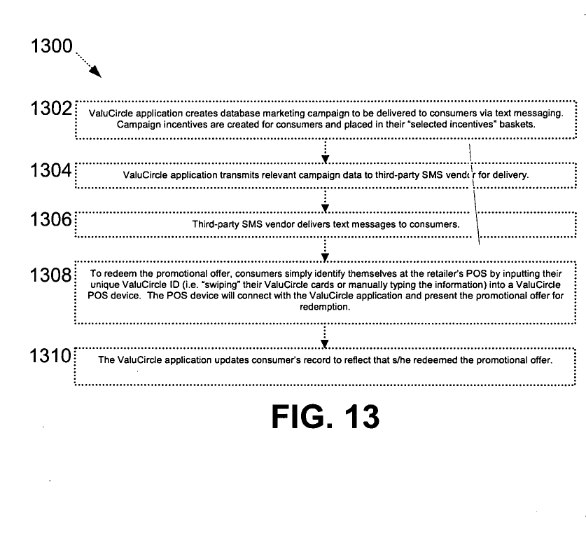

FIG. 13 is a flowchart of a process 1300 for using text messaging to deliver incentives to one or more consumers in accordance with an embodiment of the incentive management system. In operation 1302, the digital incentive manager may create a database marketing campaign for delivery to consumers via text messaging. Campaign incentives may be created for consumers and placed in their “selected incentives” baskets. In operation 1304, the digital incentive manager may transmit relevant campaign data to a third-party SMS vendor for delivery to the consumer via text messaging. In operation 1306, the third-party SMS vendor may deliver the text messages to consumers.

To redeem the promotional offer, consumers may identify themselves at the retailer's POS by inputting their unique ID (i.e. “swiping” their incentive cards and/or manually typing the information) into a POS device of the digital incentive system in operation 1308. The POS device may connect with the digital incentive manager and present the promotional offer for redemption. In operation 1310, the digital incentive manager may update the consumer's record to reflect that the consumer redeemed the promotional offer.

Exemplary Network

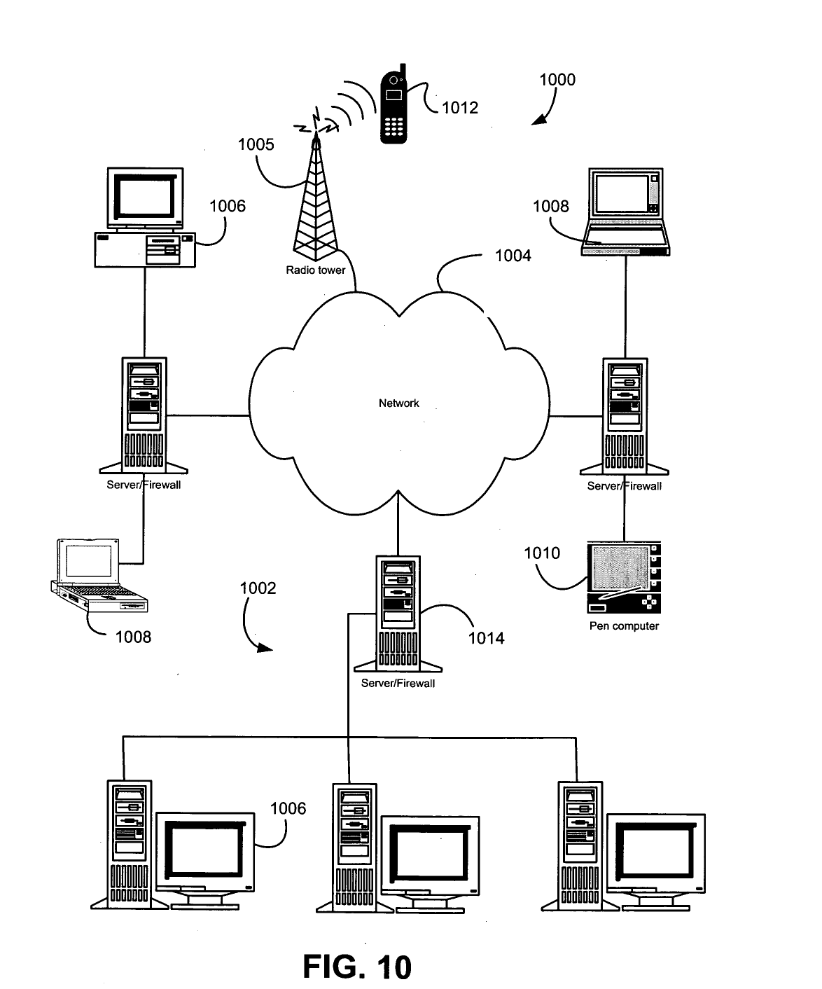

FIG. 10 illustrates an exemplary network system 1000 with a plurality of components 1002 in accordance with one embodiment of the present invention. As shown, such components include a network 1004 which take any form including, but not limited to a local area network, a wide area network such as the Internet, and a wireless network 1005. Coupled to the network 1004 is a plurality of computers which may take the form of desktop computers 1006, lap-top computers 1008, hand-held computers 1010 (including wireless devices 1012 such as wireless PDA's or mobile phones), or any other type of computing hardware/software. As an option, the various computers may be connected to the network 1004 by way of a server 1014 which may be equipped with a firewall for security purposes. It should be noted that any other type of hardware or software may be included in the system and be considered a component thereof.

Representative Hardware Environment

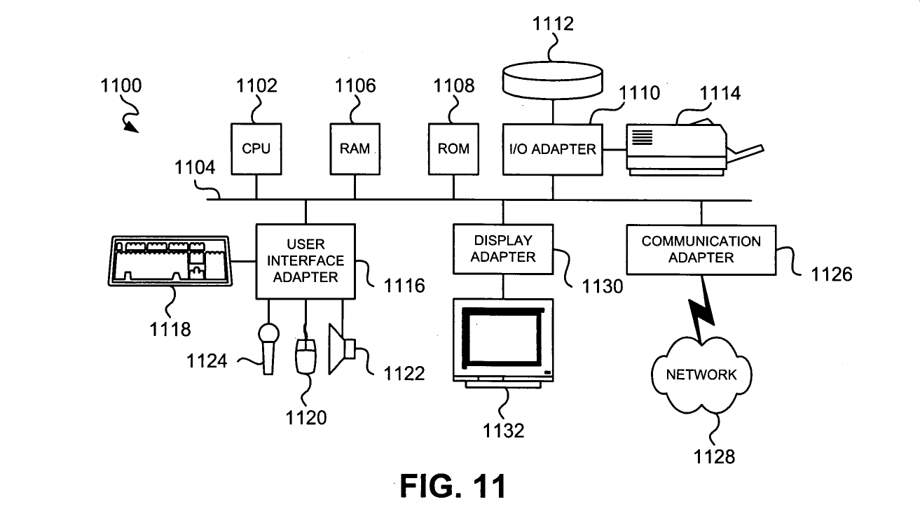

A representative hardware environment associated with the various components of FIG. 10 is depicted in FIG. 11. In the present description, the various sub-components of each of the components may also be considered components of the system. For example, particular software modules executed on any component of the system may also be considered components of the system. In particular, FIG. 11 illustrates an exemplary hardware configuration of a workstation 1100 having a central processing unit 1102, such as a microprocessor, and a number of other units interconnected via a system bus 1104.

The workstation shown in FIG. 11 includes a Random Access Memory (RAM) 1106, Read Only Memory (ROM) 1108, an I/O adapter 1110 for connecting peripheral devices such as, for example, disk storage units 1112 and printers 1114 to the bus 1104, a user interface adapter 1116 for connecting various user interface devices such as, for example, a keyboard 1118, a mouse 1120, a speaker 1122, a microphone 1124, and/or other user interface devices such as a touch screen or a digital camera to the bus 1104, a communication adapter 1126 for connecting the workstation 1100 to a communication network 1128 (e.g., a data processing network) and a display adapter 1130 for connecting the bus 1104 to a display device 1132. The workstation may utilize an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

An embodiment of the present invention may also be written using Java, C, and the C++ language and utilize object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. An embodiment of the invention utilizes HyperText Markup Language (HTML) to implement documents on the Internet together with a general-purpose secure communication protocol for a transport medium between the client and the server. HTTP or other protocols could be readily substituted for HTML without undue experimentation. Information on these products is available in T. Berners-Lee, D. Connoly, “RFC 1866: Hypertext Markup Language—2.0” (November 1995); and R. Fielding, H, Frystyk, T. Berners-Lee, J. Gettys and J. C. Mogul, “Hypertext Transfer Protocol—HTTP/1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystems's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

JavaScript is an interpreted programming or script language from Netscape. It is somewhat similar in capability to Microsoft's Visual Basic, Sun's Tcl, the UNIX-derived Perl, and IBM's REX. In general, script languages are easier and faster to code in than the more structured and compiled languages such as C and C++. JavaScript is used in Web site development to do such things as: automatically change a formatted date on a Web page; cause a linked-to page to appear in a popup window; and cause text or a graphic image to change during a mouse rollover.

JavaScript uses some of the same ideas found in Java. JavaScript code can be imbedded in HTML pages and interpreted by the Web browser (or client). JavaScript can also be run at the server as in Microsoft's Active Server Pages before the page is sent to the requestor. Both Microsoft and Netscape browsers support JavaScript.

Another technology that provides similar function to Java is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for Java without undue experimentation to practice the invention.

A technology of Active X is the component object model (COM). Used in a network with a directory and additional support, COM becomes the distributed component object model (DCOM). The main thing that you create when writing a program to run in the ActiveX environment is a component, a self-sufficient program that can be run anywhere in your ActiveX network. This component is known as an ActiveX control. ActiveX is Microsoft's answer to the Java technology from Sun Microsystems. An ActiveX control is roughly equivalent to a Java applet.

OCX stands for “Object Linking and Embedding control.” Object Linking and Embedding (OLE) was Microsoft's program technology for supporting compound documents such as the Windows desktop. The Component Object Model now takes in OLE as part of a larger concept. Microsoft now uses the term “ActiveX control” instead of “OCX” for the component object.

An advantage of a component is that it can be re-used by many applications (referred to as component containers). A COM component object (ActiveX control) can be created using one of several languages or development tools, including C++ and Visual Basic, or PowerBuilder, or with scripting tools such as VBScript.

Transmission Control Protocol/Internet Protocol (TCP/IP) is a basic communication language or protocol of the Internet. It can also be used as a communications protocol in the private networks called intranet and in extranet. When you are set up with direct access to the Internet, your computer is provided with a copy of the TCP/IP program just as every other computer that you may send messages to or get information from also has a copy of TCP/IP.

TCP/IP is a two-layering program. The higher layer, Transmission Control Protocol (TCP), manages the assembling of a message or file into smaller packet that are transmitted over the Internet and received by a TCP layer that reassembles the packets into the original message. The lower layer, Internet Protocol (IP), handles the address part of each packet so that it gets to the right destination. Each gateway computer on the network checks this address to see where to forward the message. Even though some packets from the same message are routed differently than others, they'll be reassembled at the destination.

TCP/IP uses a client/server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. (Note that the TCP layer itself is not stateless as far as any one message is concerned. Its connection remains in place until all packets in a message have been received.).

Many Internet users are familiar with the even higher layer application protocols that use TCP/IP to get to the Internet. These include the World Wide Web's Hypertext Transfer Protocol (HTTP), the File Transfer Protocol (FTP), Telnet which lets you logon to remote computers, and the Simple Mail Transfer Protocol (SMTP). These and other protocols are often packaged together with TCP/IP as a “suite.”

Personal computer users usually get to the Internet through the Serial Line Internet Protocol (SLIP) or the Point-to-Point Protocol. These protocols encapsulate the IP packets so that they can be sent over a dial-up phone connection to an access provider's modem.

Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Internetwork Packet Exchange (IPX) is a networking protocol from Novell that interconnects networks that use Novell's NetWare clients and servers. IPX is a datagram or packet protocol. IPX works at the network layer of communication protocols and is connectionless (that is, it doesn't require that a connection be maintained during an exchange of packets as, for example, a regular voice phone call does).

Packet acknowledgment is managed by another Novell protocol, the Sequenced Packet Exchange (SPX). Other related Novell NetWare protocols are: the Routing Information Protocol (RIP), the Service Advertising Protocol (SAP), and the NetWare Link Services Protocol (NLSP).

A virtual private network (VPN) is a private data network that makes use of the public telecommunication infrastructure, maintaining privacy through the use of a tunneling protocol and security procedures. A virtual private network can be contrasted with a system of owned or leased lines that can only be used by one company. The idea of the VPN is to give the company the same capabilities at much lower cost by using the shared public infrastructure rather than a private one. Phone companies have provided secure shared resources for voice messages. A virtual private network makes it possible to have the same secure sharing of public resources for data.

Using a virtual private network involves encryption data before sending it through the public network and decrypting it at the receiving end. An additional level of security involves encrypting not only the data but also the originating and receiving network addresses. Microsoft, 3Com, and several other companies have developed the Point-to-Point Tunneling Protocol (PPP) and Microsoft has extended Windows NT to support it. VPN software is typically installed as part of a company's firewall server.

Wireless refers to a communications, monitoring, or control system in which electromagnetic radiation spectrum or acoustic waves carry a signal through atmospheric space rather than along a wire. In most wireless systems, radio frequency (RF) or infrared transmission (IR) waves are used. Some monitoring devices, such as intrusion alarms, employ acoustic waves at frequencies above the range of human hearing.

Early experimenters in electromagnetic physics dreamed of building a so-called wireless telegraph. The first wireless telegraph transmitters went on the air in the early years of the 20th century. Later, as amplitude modulation (AM) made it possible to transmit voices and music via wireless, the medium came to be called radio. With the advent of television, fax, data communication, and the effective use of a larger portion of the electromagnetic spectrum, the original term has been brought to life again.

Common examples of wireless equipment in use today include the Global Positioning System, cellular telephone phones and pagers, cordless computer accessories (for example, the cordless mouse), home-entertainment-system control boxes, remote garage-door openers, two-way radios, and baby monitors. An increasing number of companies and organizations are using wireless LAN. Wireless transceivers are available for connection to portable and notebook computers, allowing Internet access in selected cities without the need to locate a telephone jack. Eventually, it will be possible to link any computer to the Internet via satellite, no matter where in the world the computer might be located.

A Global Positioning System (GPS) comprises a number of satellites orbiting the Earth that make it possible for user with GPS receivers to pinpoint their geographic location. In general, the satellites may be spaced apart so that from any point on Earth, four satellites will be above the horizon. Each satellite contains a computer, an atomic clock, and a radio. With an understanding of its own orbit and the clock, the satellite continually broadcasts its changing position and time. (Once a day, each satellite checks its own sense of time and position with a ground station and makes any minor correction.) The GPS receiver includes a computer that “triangulates” its own position by getting bearings from three of the four satellites. The result is provided in the form of a geographic position in longitude and latitude. A GPS receiver may also be equipped with a display screen that shows a map so that the receiver's position can be shown on the map. In addition, if a fourth satellite may be received, the receiver/computer may be able to calculate the altitude of the receiver.

Bluetooth is a computing and telecommunications industry specification that describes how mobile phones, computers, and personal digital assistants (PDA's) can easily interconnect with each other and with home and business phones and computers using a short-range wireless connection. Each device is equipped with a microchip transceiver that transmits and receives in a previously unused frequency band of 2.45 GHz that is available globally (with some variation of bandwidth in different countries). In addition to data, up to three voice channels are available. Each device has a unique 48-bit address from the IEEE 802 standard. Connections can be point-to-point or multipoint. The maximum range is 10 meters. Data can be presently be exchanged at a rate of 1 megabit per second (up to 2 Mbps in the second generation of the technology). A frequency hop scheme allows devices to communicate even in areas with a great deal of electromagnetic interference. Built-in encryption and verification is provided.

Wi-Fi (short for “wireless fidelity”) is a high-frequency wireless local area network (WLAN). The Wi-Fi technology may be used as an alternative to a wired LAN. Wi-Fi technology may also be installed for a home network. Wi-Fi is specified in the 802.11b specification from the Institute of Electrical and Electronics Engineers (IEEE) and is part of a series of wireless specifications together with 802.11, 802.11a, and 802.11g. All four standards use the Ethernet protocol and CSMA/CA (carrier sense multiple access with collision avoidance) for path sharing.

The 802.11b (Wi-Fi) technology operates in the 2.4 GHz range offering data speeds up to 11 megabits per second. The modulation used in 802.11 may be (and has historically been) phase-shift keying (PSK). The modulation method selected for 802.11b is known as complementary code keying (CCK), which allows higher data speeds and is less susceptible to multipath-propagation interference.

Unless adequately protected, a Wi-Fi wireless LAN may be susceptible to access from the outside by unauthorized users, some of whom have used the access as a free Internet connection. Some exemplary security safeguards that may be implemented to protect a Wi-Fi wireless LAN include, for example, the Wired Equivalent Privacy (WEP) encryption standard, the setup and use of a virtual private network (VPN) or IPsec, and a firewall or DMZ.

Encryption is the conversion of data into a form, called a ciphertext, that cannot be easily understood by unauthorized people. Decryption is the process of converting encrypted data back into its original form, so it can be understood.

The use of encryption/decryption is as old as the art of communication. In wartime, a cipher, often incorrectly called a “code,” can be employed to keep the enemy from obtaining the contents of transmissions (technically, a code is a means of representing a signal without the intent of keeping it secret; examples are Morse code and ASCII). Simple ciphers include the substitution of letters for numbers, the rotation of letters in the alphabet, and the “scrambling” of voice signals by inverting the sideband frequencies. More complex ciphers work according to sophisticated computer algorithm that rearrange the data bits in digital signals.

In order to easily recover the contents of an encrypted signal, the correct decryption key is required. The key is an algorithm that “undoes” the work of the encryption algorithm. Alternatively, a computer can be used in an attempt to “break” the cipher. The more complex the encryption algorithm, the more difficult it becomes to eavesdrop on the communications without access to the key.

Rivest-Shamir-Adleman (RSA) is an Internet encryption and authentication system that uses an algorithm developed in 1977 by Ron Rivest, Adi Shamir, and Leonard Adleman. The RSA algorithm is a commonly used encryption and authentication algorithm and is included as part of the Web browser from Netscape and Microsoft. It's also part of Lotus Notes, Intuit's Quicken, and many other products. The encryption system is owned by RSA Security.

The RSA algorithm involves multiplying two large prime numbers (a prime number is a number divisible only by that number and 1) and through additional operations deriving a set of two numbers that constitutes the public key and another set that is the private key. Once the keys have been developed, the original prime numbers are no longer important and can be discarded. Both the public and the private keys are needed for encryption/decryption but only the owner of a private key ever needs to know it. Using the RSA system, the private key never needs to be sent across the Internet.

The private key is used to decrypt text that has been encrypted with the public key. Thus, if a first party sends a message to a second party, the recipient second party may be able to find out the first party's public key (but not the first party's private key) from a central administrator and encrypt a reply message back to the first party using the first party's own public key. When the first party receives the reply message, the reply message may be decrypted by the first party with the first party's private key. In addition to encrypting messages (which ensures privacy), a first party may be able authenticate themselves to second party so that the second party can confirm the identity of the first party (and thus know that it is really the first party who sent the message) by using a private key to encrypt a digital certificate. When the second party receives the encrypted digital certificate, the second party may use the first party's public key to decrypt it.

Wired Equivalent Privacy (WEP) is a security protocol, specified in the IEEE Wireless Fidelity (Wi-Fi) standard, 802.11b, that is designed to provide a wireless local area network (WLAN) with a level of security and privacy comparable to what is usually expected of a wired LAN. In general, a wired local area network (LAN) may be protected by physical security mechanisms (controlled access to a building, for example) that are effective for a controlled physical environment, but may be ineffective for WLANs because radio waves are not necessarily bound by the walls containing the network. WEP may be utilized to help establish similar protection to that offered by the wired network's physical security measures by encrypting data transmitted over the WLAN. Data encryption may be utilized to protect the vulnerable wireless link between clients and access points. Once such a measure has been taken, other LAN security mechanisms such as, for example, password protection, end-to-end encryption, virtual private networks (VPNs), and authentication may be utilized to help ensure privacy.

A pop-up is a graphical user interface (GUI) display area, usually a small window, that suddenly appears (“pops up”) in the foreground of the visual interface. Pop-ups can be initiated by a single or double mouse click or rollover (sometimes called a mouseover), and also possibly by voice command or can simply be timed to occur. A pop-up window is usually smaller than the background window or interface; otherwise, it is may be called a replacement interface.

On the World Wide Web, JavaScript (and less commonly Java applets) may be used to create interactive effects including pop-up and full overlay windows. A menu or taskbar pulldown can be considered a form of pop-up. So can the little message box you get when you move your mouse over taskbars in many PC applications.

Plug-in applications are programs that can easily be installed and used as part of your Web browser. Initially, the Netscape browser allowed you to download, install, and define supplementary programs that played sound or motion video or performed other functions. These were called helper applications. However, these applications run as a separate application and require that a second window be opened. A plug-in application is recognized automatically by the browser and its function is integrated into the main HTML file that is being presented.

Plug-in applications are programs that can easily be installed and used as part of your Web browser. Initially, the Netscape browser allowed you to download, install, and define supplementary programs that played sound or motion video or performed other functions. These were called helper applications. However, these applications run as a separate application and require that a second window be opened. A plug-in application is recognized automatically by the browser and its function is integrated into the main HTML file that is being presented.

A browser is an application program that provides a way to look at and interact with all the information on the World Wide Web. The word “browser” seems to have originated prior to the Web as a generic term for user interfaces that let you browse (navigate through and read) text files online. By the time the first Web browser with a GUI was generally available (Mosaic, in 1993), the term seemed to apply to Web content, too. Technically, a Web browser may be considered a client program that uses the Hypertext Transfer Protocol (HTTP) to make requests of Web servers throughout the Internet on behalf of the browser user. Many of the user interface features in Mosaic, however, went into the first widely-used browser, Netscape Navigator. Microsoft followed with its Microsoft Internet Explorer. Lynx is a text-only browser for UNIX shell and VMS users. Another browser is Opera. While some browsers also support e-mail (indirectly through e-mail Web sites) and the File Transfer Protocol (FTP), a Web browser may not be required for those Internet protocols and more specialized client programs are more popular.

Hashing is the transformation of a string of characters into a usually shorter fixed-length value or key that represents the original string. Hashing may be used to index and retrieve items in a database because it is faster to find the item using the shorter hashed key than to find it using the original value. It may also used in encryption algorithms. A hashing algorithm is called the hash function. Hashing may also used to encrypt and decrypt digital signatures (used to authenticate message senders and receivers). The digital signature is transformed with the hash function and then both the hashed value (known as a message-digest) and the signature are sent in separate transmissions to the receiver. Using the same hash function as the sender, the receiver derives a message-digest from the signature and compares it with the message-digest it also received. They should be the same. The hash function may be used to index the original value or key and then used later each time the data associated with the value or key is to be retrieved. Thus, hashing is always a one-way operation. There's no need to “reverse engineer” the hash function by analyzing the hashed values. In fact, the ideal hash function can't be derived by such analysis. A good hash function also should not produce the same hash value from two different inputs. If it does, this is known as a collision. A hash function that offers an extremely low risk of collision may be considered acceptable.

Some exemplary hash functions include the division-remainder method, the folding method, the radix transformation method and the digit rearrangement method. In the division-remainder method, the size of the number of items in the table is estimated. That number is then used as a divisor into each original value or key to extract a quotient and a remainder. The remainder is the hashed value. The folding method divides the original value into several parts, adds the parts together, and then uses the last four digits (or some other arbitrary number of digits) as the hashed value or key. The radix transformation method may be utilized where the value or key is digital. In this method, the number base (or radix) can be changed resulting in a different sequence of digits. For example, a decimal numbered key could be transformed into a hexadecimal numbered key. High-order digits can be discarded to fit a hash value of uniform length. The digit rearrangement method is simply the taking of part of the original value or key such as digits in positions 3 through 6, reversing their order, and then using that sequence of digits as the hash value or key.

A hash function that works well for database storage and retrieval might not work as for cryptographic or error-checking purposes. There are several well-known hash functions used in cryptography. These include the message-digest hash functions MD2, MD4, and MD5, used for hashing digital signatures into a shorter value called a message-digest, and the Secure Hash Algorithm (SHA), a standard algorithm, that makes a larger (60-bit) message digest and is similar to MD4.

U.S. Pat. No. 4,309,569 issued Jan. 5, 1982 to Ralph Merkle and entitled, “Method of providing digital signatures” and incorporated herein by reference describes a use of hash functions to build trees in order to authenticate an item in a list of items.

A timestamp may be an identifier for transaction that may be used to permit ordering. A timestamp may also be used to verify digital signatures and help reduce the possibility that someone will derive a private key from the public key in a digital certificate. In order to reduce the possibility that someone will derive a private key from the public key in a digital certificate, the certifying authority may issue the key pair with an expiration date so that they must be replaced periodically. Any signature applied after the digital certificate expires is invalid. To assure that a signature was applied before the certificate expired, the certifying authority can timestamp a digital signature. Essentially, that means taking the signature, adding the current time and signing them together. When a digital signature is timestamped in this way, the software can verify that the signature was applied while the certificate was still valid. U.S. Pat. No. 5,136,647 issued to S. A. Haber et al. on Aug. 4, 1992, entitled “Method for secure timestamping of digital documents” is incorporated herein by reference and discloses a variety of technological and algorithmic components of digital timestamping including the linking of timestamp requests in a sequence, a random-witness method that uses the document being timestamped to pseudo-randomly choose timestamping witnesses, the use of a single hash value to represent a timestamp request for an accumulation or collection of digital documents, and a time-stamping process that does not explicitly require the use of a digital signature.

The Secure Sockets Layer (SSL) is a commonly-used protocol for managing the security of a message transmission on the Internet. SSL has recently been succeeded by Transport Layer Security (TLS), which is based on SSL. SSL uses a program layer located between the Internet's Hypertext Transfer Protocol (HTTP) and Transport Control Protocol (TCP) layers. SSL is included as part of both the Microsoft and Netscape browsers and most Web server products. Developed by Netscape, SSL also gained the support of Microsoft and other Internet client/server developers as well and became the de facto standard until evolving into Transport Layer Security. The “sockets” part of the term refers to the sockets method of passing data back and forth between a client and a server program in a network or between program layers in the same computer. SSL uses the public-and-private key encryption system from RSA, which also includes the use of a digital certificate.

TLS and SSL are an integral part of most Web browsers (clients) and Web servers. If a Web site is on a server that supports SSL, SSL can be enabled and specific Web pages can be identified as requiring SSL access. Any Web server can be enabled by using Netscape's SSLRef program library which can be downloaded for noncommercial use or licensed for commercial use. TLS and SSL are not interoperable. However, a message sent with TLS can be handled by a client that handles SSL but not TLS.

A SSL protocol is described in the SSL Protocol Version 3.0 by the Transport Layer Security Working Group, Nov. 18, 1996 for providing communications privacy over the Internet and allowing client/server applications to communicate in a way that is designed to prevent eavesdropping, tampering, or message forgery, the disclosure of which is incorporated herein by reference in its entirety.

Transport Layer Security (TLS) is a protocol that ensures privacy between communicating applications and their users on the Internet. When a server and client communicate, TLS ensures that no third party may eavesdrop or tamper with any message. TLS is a successor to the Secure Sockets Layer (SSL). TLS is composed of two layers: the TLS Record Protocol and the TLS Handshake Protocol. The TLS Record Protocol provides connection security with some encryption method such as the Data Encryption Standard (DES). The TLS Record Protocol can also be used without encryption. The TLS Handshake Protocol allows the server and client to authenticate each other and to negotiate an encryption algorithm and cryptographic keys before data is exchanged. The TLS protocol is based on Netscape's SSL 3.0 protocol; however, TLS and SSL are not interoperable. The TLS protocol does contain a mechanism that allows TLS implementation to back down to SSL 3.0. A TLS protocol is described in the document entitled, “The TLS Protocol, Version 1” by the Network Working Group of the Internet Society, 1999, the disclosure of which is incorporated herein by reference in its entirety. This document specifies Version 1.0 of the Transport Layer Security (TLS) protocol. The TLS protocol provides communications privacy over the Internet. The protocol allows client/server applications to communicate in a way that is designed to prevent eavesdropping, tampering, or message forgery.

Wireless Transport Layer Security (WTLS) is the security level for Wireless Application Protocol (WAP) applications. Based on Transport Layer Security (TLS) v1.0 (a security layer used in the Internet, equivalent to Secure Socket Layer 3.1), WTLS was developed to address the problematic issues surrounding mobile network devices—such as limited processing power and memory capacity, and low bandwidth—and to provide adequate authentication, data integrity, and privacy protection mechanisms.

Wireless transactions, such as those between a user and their bank, require stringent authentication and encryption to ensure security to protect the communication from attack during data transmission. Because mobile networks do not provide end-to-end security, TLS had to be modified to address the special needs of wireless users. Designed to support datagrams in a high latency, low bandwidth environment, WTLS provides an optimized handshake through dynamic key refreshing, which allows encryption keys to be regularly updated during a secure session.

The Wired Equivalent Privacy (WEP) algorithm, is part of the 802.11 standard. The 802.11 standard describes the communication that occurs in wireless local area networks (LANs). The Wired Equivalent Privacy (WEP) algorithm is used to protect wireless communication from eavesdropping. A secondary function of WEP is to prevent unauthorized access to a wireless network; this function is not an explicit goal in the 802.11 standard, but it is frequently considered to be a feature of WEP. WEP relies on a secret key that is shared between a mobile station (e.g. a laptop with a wireless Ethernet card) and an access point (i.e. a base station). The secret key is used to encrypt packets before they are transmitted, and an integrity check is used to ensure that packets are not modified in transit. The standard does not discuss how the shared key is established. In practice, most installations use a single key that is shared between all mobile stations and access points.

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware to create a computer system or computer sub-system embodying the method of the invention.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed:

1. A method, comprising:
presenting a set of one or more incentives to a consumer to permit the consumer to select at least one incentive from the set of incentives, each incentive being associated with a retailer;
receiving via a network a notification that identifies the incentive selected by the consumer;
storing information relating to the selected incentive in database, the information including information that identifies the consumer, information that identifies the selected incentive, and information that identifies the retailer associated with the selected incentive;
receiving, from a point of sale of a retailer via the network, a query that identifies the consumer and the retailer, the query indicating that a sales transaction involving the customer is occurring at the point of sale of the retailer;
determining whether any of the selected incentives stored in the database are associated with the retailer;
if one or more of the selected incentives stored in the database are determined to be associated with the retailer, transmitting, to the point of sale of the retailer via the network, a reply that identifies the one or more selected incentives stored in the database determined to be associated with the retailer, the retailer determining which of the one or more selected incentives identified in the reply apply to the sales transaction with the consumer, and applying the incentives determined to apply to the sales transaction to the sales transaction;
receiving, from the point of sale of the retailer via the network, a report that identifies the incentives that were applied to the sales transaction; and
updating information stored in the database to reflect application of the incentives to the sales transaction.

2. The method of claim 1, wherein each incentive has an incentive identifier associated therewith, wherein the incentive identifier of each of the one or more selected incentives identified in the reply is included in the reply to identify the one or more selected incentives.

3. The method of claim 1, wherein the consumer inputs the incentive identifier to select the associated incentive.

4. The method of claim 3, wherein the incentive identifier is input into a wireless handheld device.

5. The method of claim 4, wherein the incentive identifier is input into the wireless handheld device utilizing text messaging.

6. The method of claim 1, wherein the set of incentives are presented to the consumer at a kiosk coupled to the network, wherein the one or more incentives included in the set of incentives is dependent on a location of the kiosk.

7. The method of claim 6, wherein the kiosk is located adjacent in a location of the retailer associated with at least one of incentives included in the set of incentives presented to the consumer.

8. The method of claim 7, further comprising: monitoring frequency that consumers access the kiosk, and reporting the frequency of access to the retailer via the network.

9. The method of claim 1, wherein the one or more incentives included in the set of incentives are selected based on responses of the consumer to a survey presented to the user via the network.

10. The method of claim 1, wherein the incentive selected by the consumer is associated with one or more additional incentives subsequently presented to the consumer.

11. The method of claim 10, wherein the one or more additional incentives are presented via the network to the consumer upon receipt of the notification identifying the associated selected incentive.

12. The method of claim 10, wherein the one or more additional incentives are presented via the network to the consumer after determining from the report received from the point of sale of the retailer that the associated selected incentive was applied to the sales transaction.

13. The method of claim 10, wherein the additional incentives comprise incentives associated with another retailer different than the retailer associated with the selected incentive.

14. The method of claim 10, wherein the incentive selected by the consumer relates to a service provided by a wireless network communication provider.

15. The method of claim 10, wherein the consumer is permitted to preview the one or more incentives prior to selecting an incentive from the set of incentives.

16. The method of claim 10, wherein the consumer is permitted to browse the set of incentives via a browser to view the associations between the incentives.

17. The method of claim 1, further comprising receiving an unique consumer identifier from the consumer prior to presentment of the set of incentives, the consumer identifier being utilized to determine which of a plurality of pre-existing incentives to include in the set of incentives.

18. The method of claim 17, wherein the consumer identifier is included in a portable storage media of the consumer, and wherein the consumer identifier is obtained from the portable storage media upon coupling of the portable storage media to the network.

19. The method of claim 17, wherein the consumer identifier is provided by the consumer to the point of sale of the retailer, and wherein the consumer identifier is included in the query received from the point of sale of the retailer.

20. The method of claim 1, further comprising: presenting information describing a benefit of a good or service associated with at least one incentives included in the set of incentives prior to selection by the consumer.

21. The method of claim 1, further comprising: permitting the consumer to input a calendar date of an event via the network; presenting one or more incentives relating to the event to the consumer at least a predetermined amount of time before the calendar date.

22. The method of claim 1, further comprising: permitting the consumer to input comments about at least one of the retailers and the selected incentive at the point of sale of the retailer during the sale transaction, receiving the comments from the point of sale of the retailer via the network; and storing the comment in the database.

23. The method of claim 22, further comprising: presenting another incentive to the consumer based on the content of the comment.

24. The method of claim 1, further comprising: presenting the retailer with a first list of incentives associated with the retailer via the network and a second list identifying incentives associated with the retailer that have been redeemed by one or more consumers.

25. The method of claim 24, wherein the first and second lists are presented to the retailer utilizing a network browser.

26. The method of claim 24, wherein a third list of incentives is presented to the retailer, the third list of incentives identifying incentives associated with the retailer that have been selected by the consumer and not yet redeemed.

27. The method of claim 1, further comprising: providing an interface for permitting the retailer create an incentive utilizing at least one of an incentive template and a pre-existing incentive.

28. The method of claim 1, further comprising transmitting an email message to the consumer upon completion of the sale transaction, the email including at least one further incentive capable of being selected by the consumer via the network.

29. The method of claim 1, wherein one or more additional incentives are presented to the consumer after receipt of the query.

30. The method of claim 29, wherein the one or more additional incentives are presented to the consumer via a wireless handheld device.

31. The method of claim 29, wherein the one or more additional incentives are presented to the consumer utilizing text messaging.

32. The method of claim 29, wherein the one or more additional incentives presented to the consumer are associated with one or more retailers a predetermined distance from the point of sale.

33. The method of claim 1, wherein a reminder associated with one of the selected incentives is presented to the user subsequent selection of the incentive.

34. The method of claim 1, wherein at least one of the selected incentives has an expiration time after which the incentive may not be redeemed by the consumer, and wherein a notice is transmitted to the consumer a predetermined amount of time prior to the expiration time.

35. The method of claim 34, wherein the notice is presented to the consumer utilizing text messaging.

36. The method of claim 1, wherein the consumer selects the at least one incentive via the network utilizing a browser.

37. A system, comprising:
logic for presenting a set of one or more incentives to a consumer to permit the consumer to select at least one incentive from the set of incentives, each incentive being associated with a retailer;
logic for receiving via a network a notification that identifies the incentive selected by the consumer;
logic for storing information relating to the selected incentive in database, the information including information that identifies the consumer, information that identifies the selected incentive, and information that identifies the retailer associated with the selected incentive;
logic for receiving, from a point of sale of a retailer via the network, a query that identifies the consumer and the retailer, the query indicating that a sales transaction involving the customer is occurring at the point of sale of the retailer;
logic for determining whether any of the selected incentives stored in the database are associated with the retailer;
if one or more of the selected incentives stored in the database are determined to be associated with the retailer, logic for transmitting, to the point of sale of the retailer via the network, a reply that identifies the one or more selected incentives stored in the database determined to be associated with the retailer, the retailer determining which of the one or more selected incentives identified in the reply apply to the sales transaction with the consumer, and applying the incentives determined to apply to the sales transaction to the sales transaction;
logic for receiving, from the point of sale of the retailer via the network, a report that identifies the incentives that were applied to the sales transaction; and
logic for updating information stored in the database to reflect application of the incentives to the sales transaction.

38. A computer program product, comprising:
computer code for presenting a set of one or more incentives to a consumer to permit the consumer to select at least one incentive from the set of incentives, each incentive being associated with a retailer;
computer code for receiving via a network a notification that identifies the incentive selected by the consumer;
computer code for storing information relating to the selected incentive in database, the information including information that identifies the consumer, information that identifies the selected incentive, and information that identifies the retailer associated with the selected incentive;
computer code for receiving, from a point of sale of a retailer via the network, a query that identifies the consumer and the retailer, the query indicating that a sales transaction involving the customer is occurring at the point of sale of the retailer;
computer code for determining whether any of the selected incentives stored in the database are associated with the retailer;
if one or more of the selected incentives stored in the database are determined to be associated with the retailer, computer code for transmitting, to the point of sale of the retailer via the network, a reply that identifies the one or more selected incentives stored in the database determined to be associated with the retailer, the retailer determining which of the one or more selected incentives identified in the reply apply to the sales transaction with the consumer, and applying the incentives determined to apply to the sales transaction to the sales transaction;
computer code for receiving, from the point of sale of the retailer via the network, a report that identifies the incentives that were applied to the sales transaction; and
computer code for updating information stored in the database to reflect application of the incentives to the sales transaction.
